(19) United States
(12) Patent Application Publication
(10) Pub. No.: US 2024/0214201 A1
(43) Pub. Date: Jun. 27, 2024

(54) ENCRYPTION PROCESSING APPARATUS AND ENCRYPTION PROCESSING METHOD

(71) Applicant: AXELL CORPORATION, Tokyo (JP)

(72) Inventors: Yusuke HOSHIZUKI, Tokyo (JP); Kotaro MATSUOKA, Tokyo (JP)

(73) Assignee: AXELL CORPORATION, Tokyo (JP)

(21) Appl. No.: 18/540,794

(22) Filed: Dec. 14, 2023

(30) Foreign Application Priority Data
Dec. 20, 2022 (JP) 2022-203161

(51) Int. Cl. H04L 9/30; H04L 9/00

(52) U.S. Cl. CPC H04L 9/3093; H04L 9/008

(57) ABSTRACT

An encryption processing apparatus processing a ciphertext is disclosed. The ciphertext is a fully homomorphic ciphertext that has a value with an error as a plaintext associated with an integer and that enables an operation between integers without decryption. The encryption processing apparatus includes a processor which executes the following processes. The processor applies a first polynomial to a first ciphertext to obtain a second ciphertext, the first polynomial being configured to be able to select an operation result in units smaller than a divided region used as one plaintext symbol corresponding to the first ciphertext in a range. The processor further convers two or more of plaintext symbols corresponding to the second ciphertext to the same one plaintext symbol by applying a second polynomial to the second ciphertext, to obtain a third ciphertext corresponding to an operation result of a predetermined operation.

### CROSS-REFERENCE TO RELATED APPLICATION

This application is based upon and claims the benefit of priority to Japanese Patent Application No. 2022−203161, filed on Dec. 20, 2022, with the Japanese Patent Office, the entire contents of which are incorporated herein by reference in its entirety.

### FIELD

The embodiments discussed herein are related to an encryption processing apparatus and an encryption processing method.

### BACKGROUND

Homomorphic encryption is an encryption technique that can process encrypted data without decrypting the encrypted data.

Encryption that allows an operation between ciphertexts, corresponding to addition of plaintexts, to be performed is additive homomorphic encryption, and encryption that allows an operation between ciphertexts, corresponding to multiplication of plaintexts, to be performed is multiplicative homomorphic encryption.

There are conventionally known additive homomorphic encryption that performs only an additive operation (addition and subtraction) while a finite cyclic group is regarded as an integer and multiplicative homomorphic encryption that performs only a multiplicative operation (multiplication) while a finite cyclic group is regarded as an integer.

For the finite cyclic group, an integral multiple can be obtained by repeating addition, and therefore an integral multiple by a plaintext can be calculated. Also, exponentiation by a plaintext can be calculated by repeating multiplication.

There are also known ring homomorphic encryption that processes both an additive operation and a multiplicative operation while ciphertexts remain encrypted and fully homomorphic encryption (FHE) that can perform all operations including addition and multiplication.

One of known fully homomorphic encryption techniques is fully homomorphic encryption based on the LWE (Learning with Errors) problem, which is configured by adding a small error to a plaintext in an encryption process to such an extent that there is no problem in decryption.

In the fully homomorphic encryption based on the LWE problem, an error is accumulated as an operation is repeated, and therefore, bootstrapping for reducing an error component while the error component remains encrypted is performed before the error becomes too large to allow decryption.

The computation time of bootstrapping occupies most of the computation time required for operation in fully homomorphic encryption. Further, the amount of computation is large in bootstrapping, because bootstrapping handles a large amount of data. Therefore, in an operation of fully homomorphic encryption, the operation result may not be able to be obtained within a practical time.

A scheme that drastically improves this problem is TFHE (Fast Fully Homomorphic Encryption over the Torus) described in TFHE: Fast Fully Homomorphic Encryption over the Torus. Journal of Cryptology, 33:34−91, 2020, I. Chillotti, N. Gama, M. Georgieva, and M.

Izabachene (referred to as “Chillotti et al., 2020” in the following descriptions).

Homomorphic encryption includes Bit-wise type homomorphic encryption having two values as a plaintext and based on a logical operation, and Integer-wise type homomorphic encryption having a whole integer as a plaintext as one ciphertext. TFHE described in Chillotti et al., 2020 is the Bit-wise type.

The plaintext in TFHE is a real number from 0 to 1 associated with a circle group. Therefore, by associating sections obtained by dividing the range from 0 to 1 of the circle group with integers in turn, TFHE can be applied as Integer-wise type homomorphic encryption having an integer as the plaintext. For example, Integerwise Functional Bootstrapping on TFHE, 2020, Hiroki Okada, Shinsaku Kiyomoto, and Carlos Cid can be mentioned.

If TFHE is used as the Integer-wise type, one cyphertext can retain a plurality of bits of information, thus enabling a more complicated operation to be performed in one homomorphic operation. The number of operation times in the entire system can thus be reduced largely.

Further, it is known that values of functions are substituted into a test vector polynomial for Bootstrapping and used as a LUT, whereby a desired univariate function can be evaluated. For example, Bootstrapping in FHEW-like Cryptosystems, 2020, Daniele Micciancio and Yuriy Polyakov (hereinafter, referred to as Micciancio and Polyakov, 2020) can be mentioned.

However, the function substituted into the test vector polynomial has to satisfy the property of ƒ(v+1/2)=−ƒ(v). Although functions satisfying this constraint include a trigonometric function, this constraint is not a general constraint, and the application thereof is difficult.

To avoid this constraint, an idea has been proposed that only the section from 0 to 0.5 on a circle group is used as a plaintext. By adding this constraint, it is possible to evaluate any univariate function regardless of the above constraint. In this case, however, information that can be retained by one ciphertext is reduced to substantially a half, i.e., by 1 bit, and the effect to be obtained by use of Integer-wise type is reduced.

### SUMMARY

According to an aspect of the embodiments, an encryption processing apparatus processes a ciphertext, the ciphertext being a fully homomorphic ciphertext that has a value with an error as a plaintext associated with an integer and that enables an operation between integers without decryption, the error having a predetermined variance in a divided region obtained by dividing a range into a predetermined number of regions. The encryption processing apparatus includes a processor which executes a process including applying a first polynomial to a first ciphertext to obtain a second ciphertext, the first polynomial being configured to be able to select an operation result in units smaller than the divided region used as one plaintext symbol corresponding to the first ciphertext in the range, and converting two or more of plaintext symbols corresponding to the second ciphertext to the same one plaintext symbol by applying a second polynomial to the second ciphertext, to obtain a third ciphertext corresponding to an operation result of a predetermined operation.

The objects and advantages of the invention will be realized and achieved by the elements and combinations specifically pointed out in the claims.

It is to be understood that both the foregoing general description and the following detailed description are exemplary and illustrative and are not intended to limit the invention as claimed.

### BRIEF DESCRIPTION OF DRAWINGS

FIG. 1 is an explanatory diagram of a functional configuration of an encryption processing apparatus of a first example;

FIGS. 2A and 2B are explanatory diagrams of an operation process based on the functional configuration in FIG. 1;

FIG. 3 is an image diagram for explaining a circle group that TLWE encryption has as a plaintext;

FIG. 4 is an operation image diagram of binary Gate Bootstrapping;

FIG. 5 is an explanatory diagram of TFHE applied to an Integer-wise type;

FIGS. 6A and 6B are explanatory diagrams of Integer-wise type TFHE in the first example;

FIG. 7 is an explanatory diagram of Integer-wise type TFHE in the first example;

FIG. 8 is an explanatory diagram of Integer-wise type TFHE in the first example;

FIG. 9 is an explanatory diagram of Integer-wise type TFHE in the first example;

FIG. 10 is an explanatory diagram of transition of a value of a ciphertext in the first example (even function);

FIG. 11 is an explanatory diagram of transition of a value of a ciphertext in the first example (even function);

FIG. 12 is an explanatory diagram of a functional configuration of an encryption processing apparatus of a second example;

FIGS. 13A and 13B are explanatory diagrams of operation processes based on the functional configuration in FIG. 12;

FIGS. 14A and 14B are an explanatory diagram of Integer-wise type TFHE in the second example;

FIG. 15 is an explanatory diagram of Integer-wise type TFHE in the second example (odd function);

FIG. 16 is an explanatory diagram of transition of a value of a ciphertext in the second example (odd function);

FIG. 17 is an explanatory diagram of Integer-wise type TFHE in the second example (even function);

FIG. 18 is an explanatory diagram of transition of a value of a ciphertext in the second example (even function);

FIGS. 19A and 19B are flowcharts for explaining processing according to the first example;

FIGS. 20A and 20B are flowcharts for explaining processing according to the second example;

FIGS. 21A and 21B are diagrams illustrating ciphertexts input to and output from Gate Bootstrapping in the present embodiment; and

FIG. 22 is a block diagram illustrating an example of a computer apparatus.

### DESCRIPTION OF EMBODIMENTS

Embodiments of the present invention are described below in detail with reference to the drawings.

In the following descriptions, an alphanumeric character sandwiched by [ ] indicates that it is a vector. An alphanumeric character sandwiched by { } indicates that it is a set.

Further, in the present specification, a “logical operation” refers to a binary or multi-value operation.

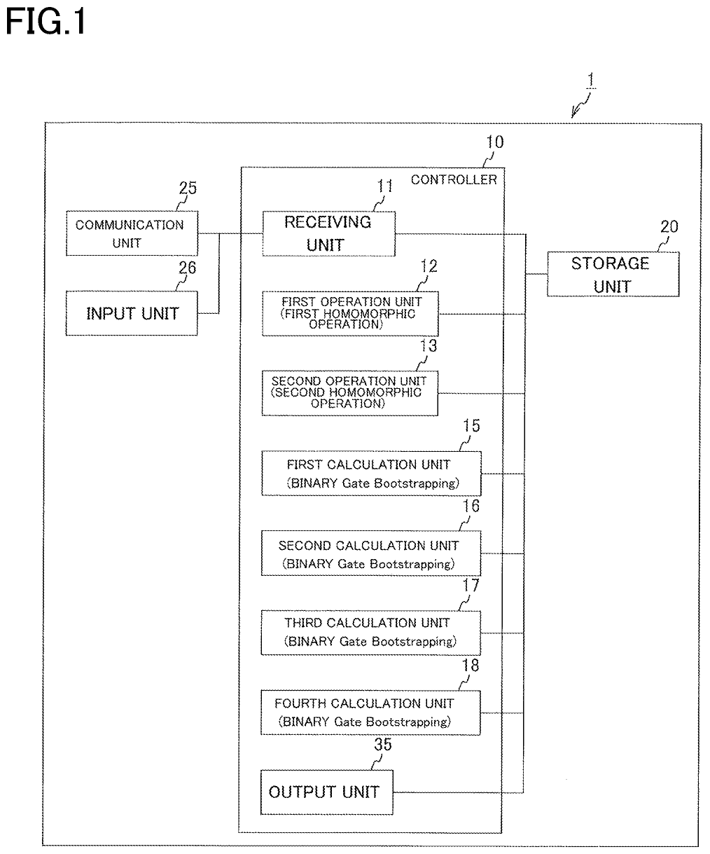

FIG. 1 is an explanatory diagram of a functional configuration of an encryption processing apparatus of a first example.

An encryption processing apparatus 1 includes a controller 10, a storage unit 20, a communication unit 25, and an input unit 26.

The controller 10 includes a receiving unit 11, a first operation unit 12, a second operation unit 13, a first Bootstrapping unit (calculation unit) 15, a second Bootstrapping unit (calculation unit) 16, a third Bootstrapping unit (calculation unit) 17, a fourth Bootstrapping unit (calculation unit) 18, and an output unit 35.

The receiving unit 11 receives input of a ciphertext that is an object of an operation, via the communication unit 25 or the input unit 26. Alternatively, the receiving unit 11 receives input of a ciphertext from another process executed by the encryption processing apparatus 1.

In an operation of an odd function as a univariate function, the first Bootstrapping unit 15 performs first Gate Bootstrapping for the input ciphertext.

The second Bootstrapping unit 16 performs second Gate Bootstrapping for the ciphertext output from the first Bootstrapping unit 15.

The first operation unit 12 performs a first homomorphic operation for the ciphertext output from the second Bootstrapping unit 16.

In an operation of an even function as a univariate function, the third Bootstrapping unit 17 performs third Gate Bootstrapping for the input ciphertext.

The second operation unit 13 performs a second homomorphic operation for the ciphertext output from the third Bootstrapping unit 17.

The fourth Bootstrapping unit 18 performs fourth Gate Bootstrapping for the ciphertext output from the second operation unit 13.

The first operation unit 12 and the second operation unit 13 are arithmetic processing units that implement homomorphic operations described below by software.

The first Bootstrapping unit 15, the second Bootstrapping unit 16, the third Bootstrapping unit 17, and the fourth Bootstrapping unit 18 are arithmetic processing units that implement Gate Bootstrapping processes described below by software.

At least one of the first operation unit 12, the second operation unit 13, the first Bootstrapping unit 15, the second Bootstrapping unit 16, the third Bootstrapping unit 17, the fourth Bootstrapping unit 18, and the output unit 35 may be implemented by hardware.

The output unit 35 outputs a final operation result to outside of the encryption processing apparatus 1 or to another processing process executed by the encryption processing apparatus 1.

The storage unit 20 can store therein an input ciphertext, a temporary file and temporary data used in an operation for ciphertexts, and an output ciphertext.

An encrypted encryption database 60 can also be stored in the storage unit 20.

The communication unit 25 connects the encryption processing apparatus 1 to a network, thereby enabling communication between the encryption processing apparatus 1 and an external device to be performed.

The encryption processing apparatus 1 can serve as a database server by storing the encrypted encryption database 60 in the storage unit 20 and including the communication unit 25.

In this case, the encryption processing apparatus 1 can receive an encrypted query from a terminal device as the external device, search the encrypted encryption database 60, and send an encrypted search result to the terminal device.

The input unit 26 inputs a ciphertext that is an object of arithmetic processing and a query for the encrypted database 60, to the encryption processing apparatus 1.

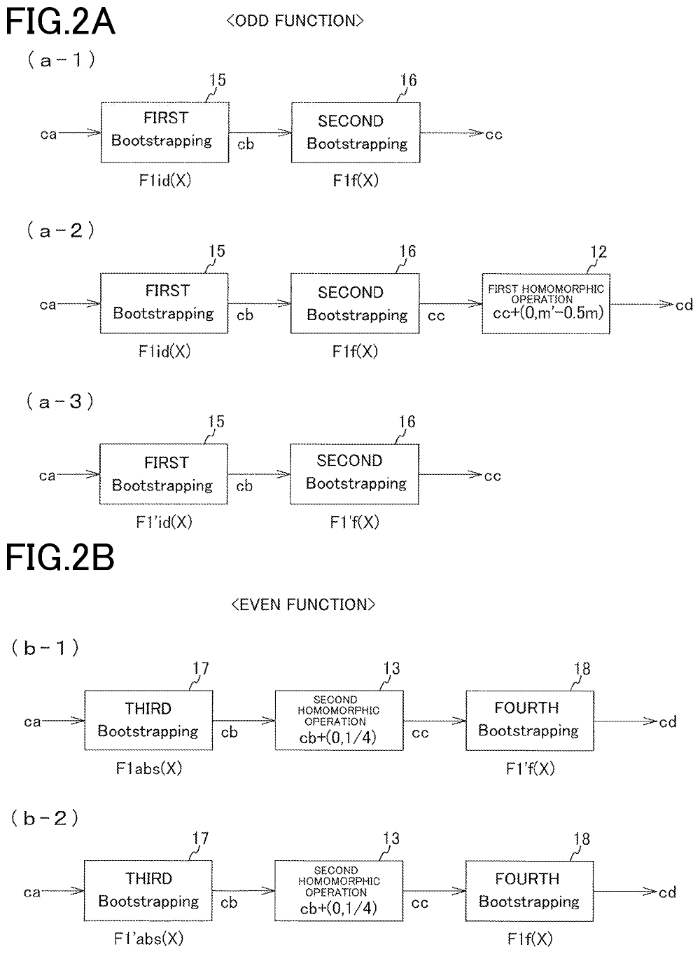

FIGS. 2A and 2B are explanatory diagrams of operation processes based on the functional configuration in FIG. 1.

The configurations illustrated in FIGS. 2A and 2B use Gate Bootstrapping presented in the aforementioned paper. Gate Bootstrapping on TFHE presented in the aforementioned paper will be described in detail below.

As described above, the encryption processing apparatus 1 performs an operation of an odd function and an operation of an even function for an Integer-wise type TLWE ciphertext.

A TLWE ciphertext ca is a ciphertext of a plaintext integer a for which an operation of an odd function and an operation of an even function are to be performed.

In FIG. 2A, the encryption processing apparatus 1 performs the operation of an odd function as a univariate function.

In (a-1), the encryption processing apparatus 1 inputs the TLWE ciphertext ca to the first Bootstrapping unit 15 and performs the first Bootstrapping using a polynomial F1id(X) as a test vector, thereby obtaining a TLWE ciphertext cb.

The encryption processing apparatus 1 then inputs the TLWE ciphertext cb to the second Bootstrapping unit 16 and performs the second Bootstrapping using a polynomial Flf(X) as a test vector, thereby obtaining a TLWE ciphertext cc corresponding to the result of calculation of the odd function.

In (a-2), the encryption processing apparatus 1 inputs the TLWE ciphertext ca to the first Bootstrapping unit 15 and performs the first Bootstrapping using the polynomial F1_{id}(X) as a test vector, thereby obtaining the TLWE ciphertext cb. The encryption processing apparatus 1 then inputs the TLWE ciphertext cb to the second Bootstrapping unit 16 and performs the second Bootstrapping using the polynomial F1_{ƒ(X) as a test vector, thereby obtaining the TLWE ciphertext cc.}

The encryption processing apparatus 1 then inputs the TLWE ciphertext cc to the first operation unit 12 and performs a first homomorphic operation to obtain a TLWE ciphertext cd corresponding to the result of calculation of the odd function.

In (a-3), the encryption processing apparatus 1 inputs the TLWE ciphertext ca to the first Bootstrapping unit 15 and performs the first Bootstrapping using a polynomial F1′_{id}(X) as a test vector, thereby obtaining the TLWE ciphertext cb.

The encryption processing apparatus 1 inputs the TLWE ciphertext cb to the second Bootstrapping unit 16 and performs the second Bootstrapping using a polynomial F1′_{ƒ(X) as a test vector, thereby obtaining the TLWE ciphertext cc corresponding to the result of calculation of the odd function.}

In FIG. 2B, the encryption processing apparatus 1 performs an operation of an even function as a univariate function.

In (b-1), the encryption processing apparatus 1 inputs the TLWE ciphertext ca to the third Bootstrapping unit 17 and performs the third Bootstrapping using a polynomial F1 _{abs}(X) as a test vector, thereby obtaining the TLWE ciphertext cb.

The encryption processing apparatus 1 inputs the TLWE ciphertext cb to the second operation unit 13 and performs a second homomorphic operation to obtain the TLWE ciphertext cc.

The encryption processing apparatus 1 inputs the TLWE ciphertext cc to the fourth Bootstrapping unit 18 and performs the fourth Bootstrapping using the polynomial F1′_{ƒ(X) as a test vector, thereby obtaining the TLWE ciphertext cd corresponding to the result of calculation of the even function.}

In (b-2), the encryption processing apparatus 1 inputs the TLWE ciphertext ca to the third Bootstrapping unit 17 and performs the third Bootstrapping using a polynomial F1′_{abs}(X) as a test vector, thereby obtaining the TLWE ciphertext cb.

The encryption processing apparatus 1 inputs the TLWE ciphertext cb to the second operation unit 13 and performs the second homomorphic operation to obtain the TLWE ciphertext cc.

The encryption processing apparatus 1 inputs the TLWE ciphertext cc to the fourth Bootstrapping unit 18 and performs the fourth Bootstrapping using the polynomial Flt(X) as a test vector, thereby obtaining the TLWE ciphertext cd corresponding to the result of calculation of the even function.

Gate Bootstrapping explained on TFHE is described in detail.

Gate Bootstrapping is a method for making fully homomorphic encryption, which has not been practical because of a huge amount of data and its operation time, practical.

TFHE in the aforementioned paper uses encryption in which LWE (Learning with Errors) encryption is configured over a circle group, so called “TLWE encryption”, and achieves various types of homomorphic logical operations (and furthermore any operation such as addition and multiplication) between TLWE ciphertexts at high speed with small data size while making an error in an operation small.

An input of Gate Bootstrapping in TFHE is a TLWE ciphertext encrypted with a private key.

TFHE achieves fully homomorphic encryption (FHE) based on TLWE ciphertexts.

TLWE encryption is a unique case of LWE encryption (obtained by defining LWE encryption over a circle group) that is one type of lattice-based cryptography.

TLWE encryption is additively homomorphic and is known as being able to perform an additive operation between plaintexts encrypted by TLWE encryption without decrypting ciphertexts.

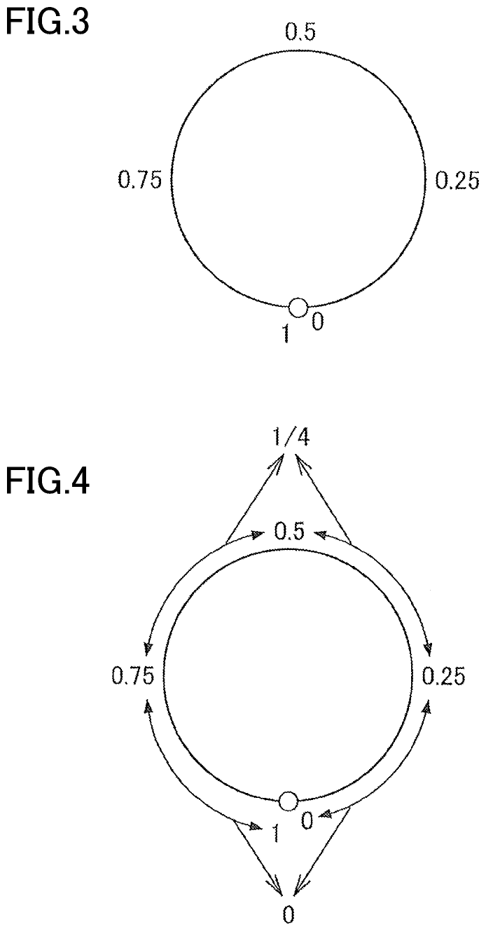

FIG. 3 is an image diagram for explaining a circle group that TLWE encryption has as a plaintext.

TLWE encryption has any point on a circle group {T} illustrated in FIG. 3, which moves from 0 to 1 with a real number precision and, when reaching 1, returns to 0, and uses a range near 0 (including an error) and a range near (including an error) as a plaintext.

The point on the circle group {T} is also described as an “element” in the present specification.

An encryption processing apparatus handling TFHE performs a generic homomorphic operation, for example, an additive operation as an operation between such TLWE ciphertexts, and makes an error of the operation result fall within an appropriate range by Gate Bootstrapping, thereby achieving fully homomorphic encryption (FHE) that allows a logical operation to be performed again (in the latter stage).

[Tlwe Encryption]

TLWE encryption is described.

A vector [a] in which N random numbers uniformly distributed are collected is prepared as an element on the circle group {T}. In addition, a private key vector [s] in which N values each being 0 or 1 at random are collected is prepared.

Assuming that a random number in the Gaussian distribution (the normal distribution) in which an average value is a plaintext and a variance is preset to a is e, an example of a TLWE ciphertext is a pair ([a], [s]·[a]+e).

An average value of e when an infinite number of TLWE ciphertexts are created for the same plaintext is a plaintext, where is a plaintext without an error and e is a plaintext with an error.

Symbol “·” represents a dot product of vectors. This description is also applied to the following descriptions.

When [s]·[a]+e described above is written as b, the TLWE ciphertext can be represented as ([a], b).

A function φₛ(([a], b))=b−[s]·[a]=e is a function of decrypting the TLWE ciphertext.

Since TLWE encryption adds a dot product of a private key vector and a random number vector and an error to a plaintext to encrypt the plaintext, TLWE encryption can be decrypted with the error by calculating the dot product of the private key vector and the random number vector. At this time, if the private key vector is unknown, a component serving as the dot product cannot be calculated, and therefore decryption cannot be performed.

This TLWE encryption is additively homomorphic and allows an additive operation between plaintexts of TLWE ciphertexts to be performed without decrypting the ciphertexts.

When ([a]+[a′], b+b′) obtained by adding two TLWE ciphertexts ([a], b) and ([a′], b′) together as they are is input to the aforementioned decryption function φₛ, a sum of the two plaintexts is obtained as represented by φₛ(([a]+[a′], b+b′))=(b+b′)−[s]·([a]+[a′])=(b−[s]·[a])+(b′−[s]·[a′])=φₛ([a′], b′)+φₛ([a′], b′). It is thus found that a TLWE ciphertext is a ciphertext obtained by “additive homomorphic encryption”.

In TFHE in the aforementioned paper, various operations are achieved by repeating “performing an additive operation for TLWE ciphertexts each obtained by adding an error to a plaintext and reducing an error by Gate Bootstrapping”.

In the following descriptions, a “trivial ciphertext” such as ([0], μ) is a TLWE ciphertext that can be decrypted with any private key, that is, a ciphertext that can be decrypted with any private key to provide the same plaintext.

In ([0], μ), [0] represents a zero vector.

Although the “trivial ciphertext” can be handled as a TLWE ciphertext, it can be considered as a state where a plaintext is placed in the ciphertext substantially as it is.

When the decryption function yₛ is applied to the TLWE ciphertext ([0], μ), the private key [s] is multiplied by the zero vector [0] to disappear as represented by φₛ(([0], μ))=μ−[s]·0=μ. The plaintext μis thus obtained easily. Such a ciphertext is a trivial ciphertext with regard to the plaintext μ.

A finite cyclic group used in Gate Bootstrapping in TFHE is described.

Gate Bootstrapping uses the property of a factor ring of a polynomial ring as a finite cyclic group.

The following description explains that a factor ring of a polynomial ring has a finite cyclic group.

An n-th order polynomial is generally represented by aₙxⁿ+aₙ₋₁xⁿ⁻¹+ . . . +α₀.

These all sets form a commutative group for the sum ƒ(x)+g(x) of polynomials.

Further, the product ƒ(x)g(x) of polynomials has properties identical to those of the commutative group except that an inverse element is not necessarily present. Such a structure is called “monoid”.

Regarding the sum and the product of polynomials, the distributive property is established as follows.

ƒ(x){g(x)+g′(x)}=ƒ(x)g(x)+ƒ(x)g′(x)

Therefore, when the sum and the product of polynomials are defined by regarding polynomials as elements, a “ring” is formed, which is called a polynomial ring.

TFHE uses a polynomial ring including the circle group {T} as coefficients, and such a polynomial ring is represented as T[X].

When a polynomial T(X), which is a polynomial ring, is decomposed into T[X](Xⁿ +1)+T[X], and only the second terms (remainders) are extracted and collected, a factor ring of a polynomial ring is obtained because the remainders also form a “ring”.

In TFHE, the factor ring of a polynomial ring is represented as T[X]/(Xⁿ +1).

A polynomial F(X)=μXⁿ⁻¹+μXⁿ⁻²+μXⁿ⁻²+ . . . +μX+μ is extracted by using a desired coefficient μ(μ belongs to T) as an element of the factor ring of the polynomial ring T[X]/(Xⁿ +1).

When the element F(X) of the factor ring of the polynomial ring is multiplied by X, μXⁿ⁻¹+μXⁿ⁻²+ . . . +μX−μ is obtained, and the coefficient of the top term appears as a constant term with a sign reversed from positive to negative. This is because only the highest order term can be divided into μμXⁿ=μ(Xⁿ+1)— although the (n−2)th term and the lower terms cannot be divided by Xⁿ+1 even after multiplication by X. Since the remainder of division by Xⁿ+1 is considered, only −μ that is the remainder on the right side remains.

When multiplication by X is further performed, the same phenomenon happens again as represented by μXⁿ⁻¹+[μXn-²+ . . . +[μX²−X- (the coefficient of the top term appears as a constant term with a sign reversed from positive to negative).

When this multiplication is repeated n times, −μXⁿ⁻¹−μXⁿ⁻² . . . −μX−μ is obtained, so that the coefficients of all terms become negative.

When multiplication by X is further continued, the coefficient of the top term becomes positive from negative and appears as a constant term as represented by

−μXⁿ⁻¹−μXⁿ⁻². . . −μX+μ,

−μXⁿ⁻¹−μXⁿ⁻². . . +μX+μ.

When multiplication by X is repeated 2n times in total, the multiplication result returns to the original element of the factor ring of the polynomial ring F(X)=μXⁿ⁻¹+μXⁿ⁻²+ . . . +μX+μ. As described above, the highest-order coefficient (μ) appears as the lowest-order constant term with a reversed sign (−μ), and terms are shifted by one in whole.

That is, the polynomial F(X)=μXⁿ⁻¹+μXⁿ⁻²+ . . . +μX+μ is a finite cyclic group of order 2n in a ring that is the factor ring of the polynomial ring TμX]/(Xⁿ +1).

In TFHE, an encryption processing apparatus achieves fully homomorphic encryption by using such properties of the polynomial F(X) based on a factor ring of a polynomial ring.

Regardless of whether the exponential part of X is positive or negative, when the element F(X) of the factor ring of the polynomial ring is repeatedly multiplied by X n times, the signs of all the terms are reversed, and when this multiplication is repeated 2n times, the signs of all the terms return to the original signs.

Further, multiplication by X⁻¹ is an inverse operation of multiplication by X. Therefore, when multiplication by X⁻¹ is repeated, change opposite to that occurring when multiplication by X is performed. That is, when multiplication by X⁻¹ is performed n times, the signs of all the terms are reversed, and when this multiplication is performed 2n times, the signs of all the terms return to the original signs.

From the above facts, when the element F(X) of the factor ring of the polynomial ring is repeatedly multiplied by X or X⁻¹ n times, the signs of all the terms are reversed, and when this multiplication is repeated 2n times, the signs of all the terms return to the original signs.

When attention is paid on the point that in this cyclic group, rotation can be done in both directions, the phrases of repeating multiplication −n times and repeating multiplication −2n times may be used, for the sake of convenience. This is merely a convenient representation for explaining the theory. When the present invention is put into practice, in a case where multiplication by X^{a} is performed −b times, for example, multiplication by X^{-a} may be performed b times or multiplication by X^{2n-a} may be performed b times. Further, other modifications may be made, as long as the same result can be achieved consequently.

[Trlwe Encryption]

Gate Bootstrapping uses encryption called TRLWE encryption in addition to TLWE encryption.

TRLWE encryption is described.

The character R in TRLWE encryption means a ring, and TRLWE encryption is LWE encryption configured by a ring. TRLWE is also additive homomorphic encryption, as TLWE encryption is.

A ring in TRLWE encryption is the factor ring of the polynomial ring TμX]/(Xⁿ +1) described above.

In order to obtain TRLWE encryption, elements of the factor ring of the polynomial ring TμX]/(Xⁿ +1) are selected at random.

In fact, n coefficients in an (n−1)th order polynomial are selected as uniformly distributed random numbers from the circle group {TI.

When the order of the polynomial is n-1, the polynomial is not divided by Xⁿ+1, and it is not necessary to consider a remainder. Therefore, it is assumed that the (n−1)th order polynomial is a polynomial a(X).

A polynomial s(X) used as a private key described below is structured as follows, by selecting n values each being 0 or 1 at random.

S(X)=Sₙ₋₁Xⁿ⁻¹+Sₙ₋₂Xⁿ⁻²+. . . s₁X+s₀

Assuming that n random numbers ei are random numbers in the Gaussian distribution (the normal distribution) in which an average value is a plaintext i and a variance is a, the following polynomial e(X) is structured from these random numbers.

ₑ(X)=φₙ₋₁Xⁿ⁻¹+φₙ₋₂Xⁿ⁻²+. . . φ₁X+φ₀

Decomposition of s(X)·a(X)+e(X) is performed into ƒ(X)(Xⁿ +1)+b(X), and b(X) is obtained.

Consequently, (a(X), b(X)) is obtained as a TRLWE ciphertext.

In TRLWE encryption, encryption is performed using random numbers similarly to TLWE encryption, and therefore innumerable ciphertexts can correspond to the same private key and the same plaintext.

In addition, in TRLWE encryption, g(X) determined in such a manner that φₛ becomes an element of TμX]/(Xⁿ +1) serves as a decryption function, where φₛ((a(X), b(X))=b(X)−s(X)·a(X)+g(X)(Xⁿ +1), as in TLWE encryption. In other words, (b(X)−s(X)·a(X))mod(Xⁿ+1) serves as a decryption function, where mod is a remainder of division.

[Gadget Decomposition]

Gadget Decomposition is described.

A coefficient in a polynomial used in a TRLWE ciphertext is a real number that is an element of the circle group {T} in FIG. 3 and is equal to or larger than 0 and less than 1, and only has a fractional part.

An operation of decomposing this coefficient into several bits in binary notation is defined as Gadget Decomposition (Dec) in TFHE in the aforementioned paper.

For example, assuming that the degree n of the polynomial F(X) of a TRLWE ciphertext is 2, one unit of decomposition is Bg=2², and decomposition into 1=3 elements is performed. At this time, each element is arranged to enter between −Bg/2 and Bg/2.

A TRLWE ciphertext is a combination of two polynomials like (a(X), b(X)) as described above. Therefore, a TRLWE ciphertext d can be written as

d=[0.75X²+0.125X+0.5,0.25X²+0.5X+0.375]

by being regarded as a two-dimensional vector having polynomials that serve as elements of a factor ring of a polynomial ring, as elements. Accordingly, in the following descriptions, each element is decomposed into the form of a sum of powers of Bg⁻¹=0.25.

Since 0.75=−0.25 is established on the circle group {T}, decomposition can be performed as follows.

$$\begin{matrix}d = [ 0.7 5 {X}^{2} + 0.125 X + 0.5 , 0.25 {X}^{2} + 0.5 X + 0.375 ] \\ = [ - 0. 25 {X}^{2} + 0.125 X + 0.5 , 0.25 {X}^{2} + 0.5 X + 0.25 + 0.125 ] \\ = [ 0.2 5 \times ( - {X}^{2} + 2 ) + 0.2 {5}^{2} \times 2 X + {0.25}^{3} \times 0 , \\ 0.25 \times ( {X}^{2} + 2 X + 1 ) + 0.25 {X}^{2} \times 2 + 0.2 {5}^{3} \times 0 ]\end{matrix}$$

Therefore, when Gadget Decomposition is performed,

a vector

Dec(d)=[−X²+2,2X,0,X²+2X+1,2,0]

is obtained.

An operator H of inverse transform from a vector to a ciphertext is also defined.

When the description is provided based on the example described above, a matrix

$$H = ( \begin{matrix}0.25 & 0 \\ {0.25}^{2} & 0 \\ {0.25}^{3} & 0 \\ 0 & 0.25 \\ 0 & {0.25}^{2} \\ 0 & {0.25}^{3}\end{matrix} )$$

becomes the operator H of the inverse transform. A TRLWE ciphertext d is obtained by performing an operation Dec(d)·H. The lower bits are rounded off.

It can also be said that an operation of obtaining [v] that makes ||d−[v]·H| minimum with respect to the TRLWE ciphertext d is Gadget Decomposition. Here, ||is a vector norm (length).

Ciphertexts Zi=(a(X), b(X)) formed by polynomials in which all coefficients of e(X) have an average value of 0 and a variance is α are created. The number of the created ciphertexts is 21.

The plaintext is encrypted in the following manner, whereby the following ciphertext k is obtained.

$$k = ( \begin{matrix}{Z}_{1} \\ {Z}_{2} \\ ⋮ \\ {Z}_{2 ℓ}\end{matrix} ) + μ \times H$$

This ciphertext k is defined as a TRGSW ciphertext BK.

The TRGSW ciphertext BK configures a Bootstrapping Key used below.

The Bootstrapping Key is described.

The Bootstrapping Key is used as a method of encrypting a private key in order to use the private key in Gate Bootstrapping. Separately from the private key [s] (Nth order) used for TLWE ciphertexts, each element of a private key [s′] for encrypting the private key [s] is selected to be either of two values, i.e., 0 or 1 for use in Gate Bootstrapping.

It is necessary to make the order of the private key [s′] the same as the order n of polynomials used in TRLWE encryption.

The TRGSW ciphertext BK is created for each element of the private key [s].

When decryption with the private key [s′] is performed, 21 TRLWE ciphertexts Zj are created where φₛ(Zj)=0 is satisfied.

BKi is then represented by

$${BK}_{i} = ( \begin{matrix}{Z}_{1} \\ {Z}_{2} \\ ⋮ \\ {Z}_{2 ℓ}\end{matrix} ) + {s}_{i} \cdot H$$

as in the above-described configuration of the TRGSW ciphertext.

This TRGSW ciphertext is prepared by using different Zj for each element in the private key [s]. A set of the TRGSW ciphertexts thus prepared is referred to as “Bootstrapping Key (BK)”. That is, the BK is a set of N TRGSW ciphertexts.

The cross product of the TRGSW ciphertext BKi and the TRLWE ciphertext d is defined as follows.

BKi×d=Dec(d)·BKi

Gadget Decomposition is an operation of obtaining [v] that makes Ild-[v]-Hl| minimum with respect to the TRLWE ciphertext d.

Therefore, by using [v]=Dec(d) and an error (a(X), Fb(X)), [v] H=d+(ₐ(X), Fb(X)) can be written.

As a result, BKixd=Dec(d)-BKi

$$= \vec{v} \cdot ( \begin{matrix}{Z}_{1} \\ {Z}_{2} \\ ⋮ \\ {Z}_{2 ℓ}\end{matrix} ) + {s}_{i} \times \vec{v} \cdot H$$

is obtained.

When the left side calculates the dot product, and [v] H=d+(ₐ(X), F_{b}(X)) is substituted into the right side,

$$\begin{matrix}= {\sum }_{j = 1}^{2 ℓ} {v}_{j} \times {Z}_{j} + {s}_{i} \times ( d + ( {ϵ}_{a} ( X ) , {ϵ}_{b} ( X ) ) ) \\ = {\sum }_{j = 1}^{2 ℓ} {v}_{j} \times {Z}_{j} + {s}_{i} \times d + {s}_{i} \times ( {ϵ}_{a} ( X ) , {ϵ}_{b} ( X ) )\end{matrix}$$

is obtained, and becomes the same as calculation of the sum of the following three ciphertexts c1, c2, and c3.

c₁= [symbol] vⱼ×Zⱼ

c₂=sᵢ×d

c3=si×(ε_{α}(X),ε_{b}(X))

Since TRLWE encryption is additive homomorphic encryption, calculating the sum of ciphertexts is the same as calculating the sum of plaintexts.

Since C₁ is obtained by adding several times of Zj, expected values of respective coefficients in the plaintext φₛ·(c₁) are all 0.

In addition, φₛφ(c₃) obtained by decryption is set to be sufficiently small also in the subsequent operations, because the magnitude of an absolute value of each coefficient in the plaintext can be adjusted by a system parameter.

In this case, φₛ·(BKi×d)=φₛ·(sᵢ×d) is obtained, but the calculation result is the sum of the above three ciphertexts c1, c2, and c3 regardless of whether sᵢ is 0 or 1. Whether sᵢ is 0 or 1 cannot be determined by a simple comparison.

Assuming that there are TRLWE ciphertexts do and dᵢ respectively corresponding to two plaintexts μ₀ and μ₁, when d₁-d₀ is substituted for d, and d₀ is finally added, the following CMux function is completed.

CMux(BKᵢ, d₀, d₁)=BKi×(d₁-d₀)+d₀=Dec(d₁-d₀)·BKᵢ+d₀

The CMux function outputs a TRLWE ciphertext of the plaintext polynomials o without decrypting the TRLWE ciphertext when si is 0, and outputs a TRLWE ciphertext of the plaintext μ₁ without decrypting the TRLWE ciphertext when sᵢ is 1.

Although the CMux function can calculate a TRLWE ciphertext corresponding to the plaintext polynomial μ₀ or the plaintext polynomial μ₁, the calculation result does not show which one is selected, without decryption of the ciphertext.

Binary Gate Bootstrapping in TFHE is performed using various information described above.

Binary Gate Bootstrapping is configured by three steps described below, i.e., (1) BlindRotate, (2) SampleExtract, and (3) Public Key Switching.

FIG. 4 is an operation image diagram of binary Gate Bootstrapping.

Binary Gate Bootstrapping reduces an error for a plaintext included in a result of a homomorphic operation between TLWE ciphertexts by three steps descried below.

In the following descriptions, unless otherwise specified, a plaintext means a result of an operation between plaintexts obtained as a result of an operation between TLWE ciphertexts.

A plaintext in a section from 0 to 0.25 (1/4) or 0.75 (3/4) to 1 on the circle group {T}in FIG. 3 is converted to a TLWE ciphertext 0, and a plaintext in a section from 0.25 (1/4) to 0.75 (3/4) is converted to a ciphertext 0.25 (1/4).

An error added to the plaintext in this conversion is any error in a range of ±1/16.
(1) BlindRotate

BlindRotate is performed as the first step of Gate Bootstrapping.

BlindRotate is a process of creating a TRLWE ciphertext.

In BlindRotate, from a trivial TRLWE ciphertext (0, T(X)) whose plaintext is a polynomial T(X), a TRLWE ciphertext multiplied by X^{φps}(c′) is obtained without decryption. “0” indicates a 0th degree polynomial 0.

Here, φs(c′) is a plaintext obtained by applying a decryption function to the following LWE ciphertext c′.

In BlindRotate, the following polynomial T(X)

T(X)=F(X)·X^{n/}2

is prepared, which is obtained by multiplying the following polynomial F(X)

F(X)=μXⁿ⁻¹+μXⁿ⁻²+. . . μX+μ

where μ=1/8, that forms the above-described finite cyclic group and serves as a test vector, by Xⁿ“2.

It is assumed that there is a TLWE ciphertext c obtained by encrypting the plaintext μ1 with the private key [s].

Each element of this TLWE ciphertext c=([a], b) is multiplied by 2n and is then rounded off, whereby a LWE ciphertext c′=([a′], b′) is obtained.

When the LWE ciphertext c′=([a′], b′) is decrypted, μ1′=φₛ(c′)≈2n×φₛ(c)=2nμ1 is obtained. While both sides are not always coincident with each other because of a rounding error, the error becomes smaller relatively as n becomes larger.

A trivial TRLWE ciphertext (0, T(X)) whose plaintext is the polynomial T(X) is prepared, and it is assumed that A₀=X^{-b′}×(0, T(X))=(0, X^{-b′}×T(X)), where 0 indicates a 0th order polynomial 0. Since b′ is an integer, exponentiation can be defined naturally. Actually, it suffices to cause a coefficient of each term of a polynomial of the TRLWE ciphertext to cycle by a predetermined number.

Subsequently, Aᵢ=CMux(BKᵢ, Aᵢ₋₁, X^{a′i}Aᵢ₋₁) is calculated in turn by using BKi that is the Bootstrapping Key described above. Since a′i is an integer also in this expression, a power of X can be defined naturally. Similarly, it suffices to cause a coefficient of each term of a polynomial that is an element of a TRLWE ciphertext Aᵢ₋₁ to cycle by a predetermined number, instead of calculating the power of X.

Accordingly, the plaintext is not changed when si is 0, and multiplication by X^{a′i} is performed in turn when sᵢ is 1.

Therefore when calculation is repeated as represented by

ϕₛ′(A₀)=X^{-b′}T(X)

ϕ_{s′}(A₁)=X^{s}^{₁}^{a′}^{₁}^{-b′}T(X)

ϕ_{s′}(A₂)=X^{s}^{₂}^{a′}^{₂}^{+s}^{₁}^{a′}^{₁}^{-b′}T(X),

then

ϕₛ′(Aₙ)=X^{Σ}^{ₜ₌₁}^{Ns}^{ᵢ}^{×a}^{ᵢ}^{′-b′}T(X)

is obtained.

Here,

Σᵢ₌₁^{N}sᵢ×aᵢ′−b′

is equal to the decryption function ys(c′) with the sign reversed. Therefore,

ϕₛ′(Aₙ)=X^{-ϕ}^{ₛ}^{(c′)}T(X)

is obtained. Here, φₛ′(Aₙ) is a polynomial obtained by multiplying the polynomial T(X) by X⁻¹ 1 μ1′times and Aₙ is its ciphertext.

It should be noted that at this time, the error component of the plaintext e with error of the first set TLWE ciphertext c appears as the amount of rotation of the polynomial T(X) but does not appear as the magnitude of the coefficient value of each term. In TFHE, the error is essentially reduced by this mechanism.

Furthermore, in association with the plaintext μ1 of the TLWE ciphertext c related to BlindRotate, unique values (up to 2n values including n coefficients and n values obtained by reversing the signs of the n coefficients) in accordance with the number of times μ1′ (=2nμ1) of multiplication of the polynomial T(X) by X⁻¹ are obtained as coefficients of constant terms of a plaintext polynomial. These values can also be regarded as a kind of lookup table.

(2) SampleExtract

In the plaintext polynomial φₛ′(Aₙ) obtained by decrypting the TRLWE ciphertext Aₙ obtained by BlindRotate in (1), n/2−φₛ(c′) terms from the lowest term have a coefficient of −μ. When φₛφ(Aₙ) is negative, coefficients are −μ from the highest term in turn conversely.

When attention is paid only to a constant term of the plaintext polynomial φₛ′(Aₙ) obtained by decrypting the TRLWE ciphertext Aₙ, the constant term is if φₛ(c′) is equal to or greater than n/2 and less than 3n/2, that is, φₛ(c) is 1/2±1/4. Otherwise, i.e., if φₛ(c) is ±1/4, the constant term is −μ.

SampleExtract is a process for extracting only the coefficient of the constant term of the plaintext polynomial φₛ′(Aₙ) from the TRLWE ciphertext Aₙ obtained by BlindRotate in (1) without decrypting the TRLWE ciphertext Aₙ, thereby obtaining a TLWE ciphertext cs.

As described above, the error added to the TLWE ciphertext c as the first input and the rounding error only affect the position of the boundary at which the plaintext and the plaintext of the constant term is switched between μ and −μ. The influence on the magnitude of the coefficient of the constant term is negligibly small. That is, it can be interpreted that an input error is removed. Further, the width within which the boundary at which the value of the plaintext of the constant term is switched can be shifted without causing any problem is the error limit within which a Bootstrapping process can be performed correctly, and serves as a mechanism of causing a trade-off described later.

The process for obtaining the TLWE ciphertext cs is described.

All TRLWE ciphertexts can be expressed as (A(X), B(X)) by putting polynomials as

$$A ( X ) = {\sum }_{i = 1}^{n} {a}_{i} {X}^{i - 1} \\ B ( X ) = {\sum }_{i = 1}^{n} {b}_{i} {X}^{i - 1}$$

where n is the order.

When decryption with the private key [s′] is performed, the expression can be expanded by putting a polynomial of the private key as

$${S}^{′} ( X ) = {\sum }_{j = 1}^{n} {s}_{j}^{′} {X}^{j - 1} .$$

### Then,

$${ϕ}_{{s}^{′}} ( c ) = B ( X ) - {S}^{′} ( X ) \cdot A ( X ) = {\sum }_{i = 1}^{n} {b}_{i} {X}^{i - 1} - {\sum }_{i = 1}^{n} {\sum }_{j = 1}^{n} {a}_{i} {s}_{j}^{′} {X}^{( i + j - 2 )}$$

is obtained.

The following operation is then performed with regard to this expression.

$$\begin{matrix}{\sum }_{i = 1}^{n} {b}_{i} {X}^{i - 1} - {\sum }_{i = 1}^{n} {\sum }_{j = 1}^{n} {a}_{i} {s}_{j}^{′} {X}^{( i + j - 2 )} = {\sum }_{i = 1}^{n} {b}_{i} {X}^{i - 1} - \\ {\sum }_{i = 1}^{n} {\sum }_{j = i - 1}^{n + i - 2} {a}_{i} {s}_{j - i + 2}^{′} {X}^{j} \\ = {\sum }_{i = 1}^{n} {{b}_{i}}^{i - 1} - \\ {\sum }_{i = 1}^{n} {\sum }_{j = i - 1}^{n - 1} {a}_{i} {s}_{j - i + 2}^{′} {X}^{j} - \\ {\sum }_{i = 1}^{n} {\sum }_{j = n}^{n + i - 2} {a}_{i} {s}_{j - i + 2}^{′} {X}^{j} \\ = {\sum }_{j = 1}^{n} {b}_{j} {X}^{j - 1} - \\ {\sum }_{j = 0}^{n - 1} {\sum }_{i = 1}^{j + 1} {a}_{i} {s}_{j - i + 2}^{′} {X}^{j} - \\ {\sum }_{j = n}^{2 n - 2} {\sum }_{i = j - n + 2}^{n} {a}_{i} {s}_{j - i + 2}^{′} {X}^{j} \\ = {\sum }_{j = 0}^{n - 1} {b}_{j + 1} {X}^{j} - \\ {\sum }_{j = 0}^{n - 1} {\sum }_{i = 0}^{j} {a}_{i + 1} {s}_{j - i + 1}^{′} {X}^{j} - \\ {\sum }_{j = 0}^{n - 2} {\sum }_{i = j - n + 1}^{- 1} {a}_{i + n + 1} {s}_{j - i + 1}^{′} {X}^{j + n} \\ = {\sum }_{j = 0}^{n - 2} {b}_{j + 1} {X}^{j} + {b}_{n} {X}^{n - 1} - \\ {\sum }_{j = 0}^{n - 2} {\sum }_{i = 0}^{j} {a}_{i + 1} {s}_{j - i + 1}^{′} {X}^{j} - \\ {\sum }_{i = 0}^{n - 1} {a}_{i + 1} {s}_{n - i}^{′} {X}^{n - 1} - \\ {\sum }_{j = 0}^{n - 2} {\sum }_{i = j - n + 1}^{- 1} {a}_{i + n + 1} {s}_{j - i + 1}^{′} {X}^{j + n} \\ = {\sum }_{j = 0}^{n - 2} ( {b}_{j + 1} {X}^{j} - \\ {\sum }_{i = 0}^{j} {a}_{i + 1} {s}_{j - i + 1}^{′} {X}^{j} - \\ {\sum }_{i = j - n + 1}^{- 1} {a}_{i + n + 1} {s}_{j - i + 1}^{′} {X}^{j + n} ) + \\ {b}_{N} {X}^{n - 1} - {\sum }_{i = 0}^{n - 1} {a}_{i + 1} {s}_{n - i}^{′} {X}^{n - 1}\end{matrix}$$

Since this is “a factor ring of a polynomial ring”, the remainder when this is divided by (Xⁿ+1) is calculated. Then,

$${\sum }_{j = 0}^{n - 2} ( {b}_{j + 1} {X}^{j} - {\sum }_{i = 0}^{j} {a}_{i + 1} {s}_{j - i + 1}^{′} {X}^{j} + {\sum }_{i = j - n + 1}^{- 1} {a}_{i + n + 1} {s}_{j - i + 1}^{′} {X}^{j} ) + {b}_{N} {X}^{n - 1} - {\sum }_{i = 0}^{n - 1} {a}_{i + 1} {s}_{n - i}^{′} {X}^{n - 1} = {\sum }_{j = 0}^{n - 2} ( {b}_{j + 1} - {\sum }_{i = 0}^{j} {a}_{i + 1} {s}_{j - i + 1}^{′} + {\sum }_{i = j - n + 1}^{- 1} {a}_{i + n + 1} {s}_{j - i + 1}^{′} ) {X}^{j} + ( {b}_{n} - {\sum }_{i = 0}^{n - 1} {a}_{i + 1} {s}_{n - i}^{′} ) {X}^{n - 1}$$

is obtained.

Further, when

$${a}_{i}^{′} = \{ \begin{matrix}{a}_{i} & ( i \geq 1 ) \\ - {a}_{i + n} & ( otherwise )\end{matrix}$$

is put, then

$$\begin{matrix}= {\sum }_{j = 0}^{n - 2} ( {b}_{j + 1} - {\sum }_{i = 0}^{j} {a}_{i + 1}^{′} {s}_{j - i + 1}^{′} - {\sum }_{i = j - n + 1}^{- 1} {a}_{i + 1}^{′} {s}_{j - i + 1}^{′} ) {X}^{j} + \\ ( {b}_{N} - {\sum }_{i = 0}^{n - 1} {a}_{i + 1}^{′} {s}_{n - i}^{′} ) {X}^{n - 1} \\ = {\sum }_{j = 0}^{n - 2} ( {b}_{j + 1} - {\sum }_{i = j - n + 1}^{j} {a}_{i + 1}^{′} {s}_{j - i + 1}^{′} ) {X}^{j} + ( {b}_{N} - {\sum }_{i = 0}^{n - 1} {a}_{i + 1} {s}_{n - i}^{′} ) {X}^{n - 1} \\ = {\sum }_{j = 0}^{n - 2} ( {b}_{j + 1} - {\sum }_{i = 0}^{n - 1} {a}_{i + j - n + 2}^{′} {s}_{n - i}^{′} ) {X}^{j} + ( {b}_{n} - {\sum }_{i = 0}^{n - 1} {a}_{i + 1} {s}_{n - i}^{′} ) {X}^{n - 1} \\ = {\sum }_{j = 0}^{n - 1} ( {b}_{j + 1} - {\sum }_{i = 0}^{n - 1} {a}_{i + j - n + 2}^{′} {s}_{n - i}^{′} ) {X}^{j}\end{matrix}$$

is obtained, and coefficients of respective terms of a plaintext polynomial are obtained from

$${ϕ}_{{s}^{′}} ( c ) = {\sum }_{j = 0}^{n - 1} ( {b}_{j + 1} - {\sum }_{i = 0}^{n - 1} {a}_{i + j - n + 2}^{′} {s}_{n - i}^{′} ) {X}^{j} .$$

Among the obtained coefficients, a coefficient of a constant term is necessary.

Therefore, when a coefficient for j=0 is extracted,

$${b}_{1} - {\sum }_{i = 0}^{n - 1} {a}_{i - n + 2}^{′} {s}_{n - i}^{′}$$

is obtained. When αᵢ^{u}=a′₋ₗ₊₂ is put, the extracted coefficient can be deformed into a decryption function of TLWE encryption as represented by

$${b}_{1} - {\sum }_{i = 0}^{n - 1} {a}_{n - i}^{″} {s}_{n - i}^{′} = {b}_{1} - {\sum }_{i = 0}^{n - 1} {a}_{i}^{″} {s}_{i}^{′} = {b}_{1} - \vec{{s}^{′}} \cdot \vec{{a}^{″}} = {ϕ}_{{s}^{′}} ( \vec{{a}^{″}} , {b}_{1} ) .$$

That is, when coefficients are extracted from the TRLWE ciphertext Aₙ=(A(X), B(X)) obtained by BlindRotate in (1) while the coefficients are set as

$${a}_{i}^{″} = \{ \begin{matrix}{a}_{1} & ( i = 1 ) \\ - {a}_{- i + n + 2} & ( otherwise )\end{matrix} ,$$

a new TLWE ciphertext ([a” ], b₁) is obtained which has, as a plaintext, the same value as a constant term of a plaintext polynomial corresponding to the original TRLWE ciphertext Aₙ.

This new TLWE ciphertext is the output of SampleExtract and has either of two types of plaintexts, i.e., −μor μ.

A trivial ciphertext ([0], μ) of which the plaintext is μis added to the thus obtained TLWE ciphertext, thereby obtaining a TLWE ciphertext cs=([a” ], b1)+([0], μ).

Specifically, since k=1/8 in the polynomial F(X) as a test vector, a ciphertext of −1/8 or 1/8 is obtained in this stage.

When the trivial TLWE ciphertext ([0], μ1/8) of which the plaintext is =1^{/}8 is added to this ciphertext,

−1/8+1/8=0

1/8+1/8=1/4

are established, and thus a new TLWE ciphertext cs having either of two values, i.e., 0 or 1/4 as the plaintext is obtained.

(3) Public Key Switching

The TLWE ciphertext cs obtained in SampleExtract in (2) is encrypted with the private key [s′], not with the private key [s].

Therefore, it is necessary to replace the key of the TLWE ciphertext cs with the private key [s] and return the state of the ciphertext to a state where encryption has been performed with the private key [s], without decrypting the TLWE ciphertext cs.

Therefore, a method of Public Key Switching is described.

The private key [s] for a TLWE ciphertext used in TFHE is an N-th order vector.

By using this vector, the private key [s′] that is an n-th order vector when the Bootstrapping Key has been created is encrypted.

That is, the private key [s′] is encrypted as a value obtained by shifting an element of the circle group {T} to each digit of a real number from 0 to 1 in binary notation, as represented by

sᵢ′×2⁻¹sᵢ′×2⁻²sᵢ′×2⁻³

The private key is [s]. The “number of digits” t is a system parameter.

When decryption is performed with the private key [s],

ϕₛ(Ks_{i,j})=s′×2^{-j}

is obtained. This is a “key switching key”.

As described above, the TLWE ciphertext cs=([a], b) obtained in (2) is 0 or 1/4 obtained by encryption with the private key [s′]. The number of elements of [a] is the same as that of the private key [s′] and is n.

When the elements are converted to t-bit fixed-point numbers by one each, the t-bit fixed point numbers can be written in the following form.

αᵢ≈Σⱼ₌₁^{t}α_{i,j}×^{2-j}

Although an error is increased in this stage, the maximum value of the absolute value can be limited by a system parameter.

As main processing of Public Key Switching, the following TLWE ciphertext cx is calculated.

cx=(\vec{0},b)−Σᵢ₌₁ⁿΣⱼ₌₁^{t}α_{i,j}×KS_{i,j}

Since the term ([0], μb) is a trivial ciphertext, this term is b when being decrypted. A result of decryption of the TLWE ciphertext cx is as follows.

ϕₛ(cx)=b−Σᵢ₌₁ⁿΣⱼ₌₁^{t}α_{i,j}×sᵢ′×2^{-j}=b−Σᵢ₌₁ⁿΣⱼ₌₁^{t}sᵢ×α_{i,j}×2^{-j}

Since s′ᵢ is a constant for j, it is factored out as follows.

=b−Σᵢ₌₁ⁿsᵢ′Σⱼ₌₁^{t}a_{i,j}×2^{-j}

The expression obtained in decomposition into the fixed-point numbers is then substituted.

≈b−Σᵢ₌₁ⁿsᵢ′×αᵢ=ϕₛ′((\vec{a},b))=ϕₛ′(cₛ)

As a result,

#ₛ(cx)≈ϕₛ′(Cₛ)

is obtained, and key switching is successful.

The TLWE ciphertext cx obtained here is encrypted with the private key [s] that is the same as the private key for the TLWE ciphertext c used as the input of Gate Bootstrapping.

By performing the processing of Public Key Switching, the ciphertext returns to the TLWE ciphertext encrypted with the private key [s], so that its plaintext φₛ(cx) is 0 when φₛ(c) is in a range of ±1/4, and is 1/4 when φₛ(c) is in a range of 1/2±1/4.

With the processing described above, a TLWE ciphertext is obtained as a result of Gate Bootstrapping, which is either of two values, i.e., 0 or 1/4 and has any error within ±1/16.

The maximum value of the error does not depend on the TLWE ciphertext c that is the input, and is a value fixed by a system parameter.

Therefore, the system parameter is set in such a manner that the maximum value of the error is any value within ±1/16 that is the same range as that for a TLWE ciphertext as the input.

This setting enables a NAND operation to be performed any number of times. The NAND operation is an operation having completeness by itself in the field of logical operations.

That is, if only the NAND operation can be realized, all logical operations can be performed by the combination thereof. Therefore, by representing any numerical value in binary, all operations including addition and multiplication can be performed.

Examples of an error added to the “plaintext” of a TLWE ciphertext output from Gate Bootstrapping include an error added by rounding-off of a TLWE ciphertext, an error added by CMux, and an error when the TLWE ciphertext is converted to a fixed-point number in Public Key Switching. All these errors can be limited by a system parameter, and the system parameter can be adjusted in such a manner that an error for which all things are considered falls within ±1/16.

The processing described above is processing of Gate Bootstrapping in TFHE.

As described above, TFHE is Bit-wise type homomorphic encryption that has zero or non-zero as the plaintext and enables a logical operation to be performed. However, the plaintext is a real number from 0 to 1 associated with the circle group {T}, as described with reference to FIG. 3. Therefore, by associating sections obtained by dividing the circle group {T} with integers in turn, TFHE can be applied as Integer-wise type homomorphic encryption having an integer as the plaintext.

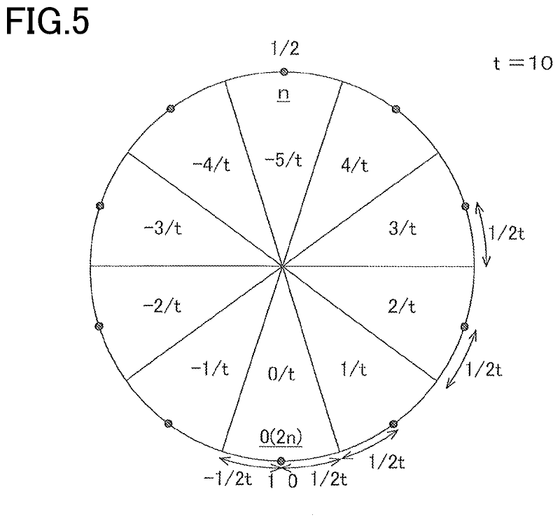

FIG. 5 is an explanatory diagram of TFHE applied to the Integer-wise type.

As illustrated in FIG. 5, the range from 0 to 1 associated with the circle group {T} is divided into t. For a TLWE ciphertext, possible values of a plaintext are t values obtained by dividing the range from 0 to 1, i.e., from −(t/2) to (t/2)-1, and (t/2)-1 is the maximum value of the integer that can be stored in one TLWE ciphertext.

As exemplified in FIG. 5, assuming that t is set to 10 and the range from 0 to 1 is divided into 10, a ciphertext can represent integers of −5, −4, −3, −2, −1, 0, 1, 2, 3, and 4. These integer values are assigned to sections centered on −5/t, −4/t, −3/t, −2/t, −1/t, 0/t, 1/t, 2/t, 3/t, and 4/t that are obtained by dividing the range of 0 to 1 of the circle group {T} into t=10, respectively. By this assignment, integers can be successively assigned counterclockwise from the region that is centered on 1/2 and is the minimum value when being represented by an integer, as illustrated in FIG. 5.

As illustrated in FIG. 5, 0(1) on the circle group {T} is within the range of the region from −1/(2t) to 1/2t.

As for a plaintext of a ciphertext on the circle group {T}, the position in the region (the position on the circle group {T}) can be adjusted by adding or subtracting an offset based on, for example, 1/(2t) to/from the state in FIG. 5, as necessary.

In the embodiment described below, the meaning of the division number t of the circle group is different from that in the description related to FIG. 5, although it is essentially unchanged.

[First Example: Division into Even Number of Regions]

Calculation of an odd function and calculation of an even function in a case where a circle group is divided into an even number of regions are described below.

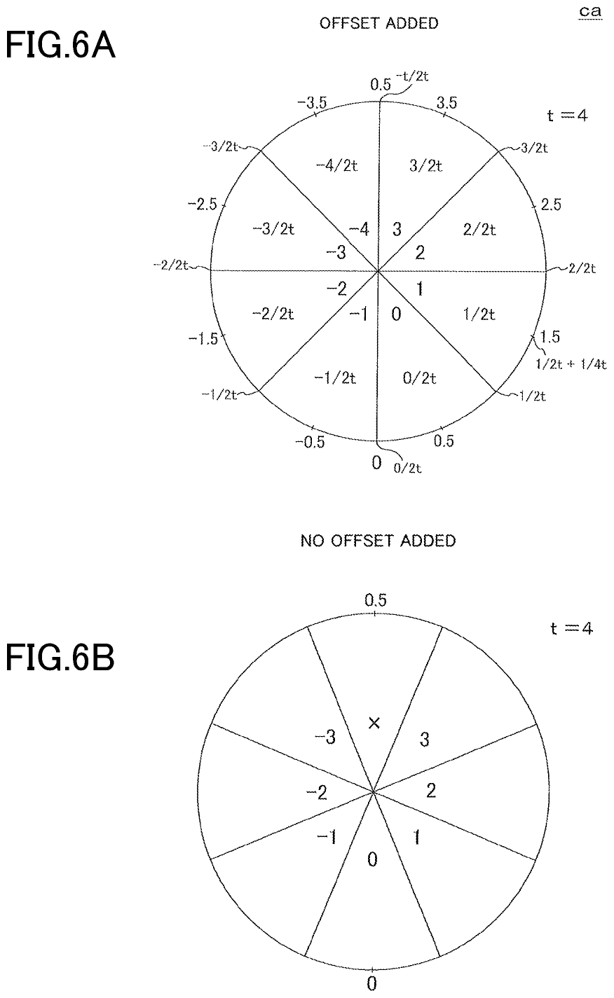

FIGS. 6A to 8 are explanatory diagrams of Integer-wise type TFHE in the first example.

In FIGS. 6A and 6B, the circle group {T} is divided into an even number of divided regions.

These divided regions are referred to as slices in the following description.

A state where no offset is added to a plaintext (the offset for the plaintext is 0) is illustrated in FIG. 6B, similarly to FIG. 5.

FIG. 6A illustrates a state where an offset of, for example, +1/(4t) is added to the plaintext of a ciphertext illustrated in FIG. 6B. By adding the offset, the manner of slicing the circle group {T} can be changed.

In the following description, it is assumed that the right half plane and the left half plane of a circle group are based on the state in FIG. 6A where the offset of 1/(4t) is added.

It is assumed that there is a TLWE ciphertext ca having the integer a as the plaintext used as an argument of a function ƒ to be calculated.

The TLWE ciphertext ca is a TLWE ciphertext having the configuration illustrated in FIG. 6A and divides each of the right half plane and the left half plane into t to divide the entire circle group {T} into 2t.

In the following description, the range from 0 to 1 of the circle group{T} may be described as −0.5 to 0.5 (−1/2 to 1/2).

As illustrated in FIG. 6A, the TLWE ciphertext ca has a real number a/(2t)+1/(4t) corresponding to an integer a that cannot be known without a private key, as the plaintext.

a/(2t)+1/(4t) is a plaintext without error, and a value with an error added thereto is stored as the plaintext actually. Here, the encryption processing apparatus 1 sets system parameters so as to make a range of the error added to the plaintext less than ±1/{4(t+1)}.

In the first example (division into even number of regions), as for the TLWE ciphertext ca, the right half plane of the circle group {T} is associated with a plaintext that is a non-negative integer, and the left half plane is associated with a plaintext that is a negative integer.

The fact that the plaintext of the TLWE ciphertext ca is a/(2t) is based on the fact that the entire circle group is divided into 2t.

In FIG. 6A, the left half plane of the circle group {T}, which handles negative numbers, represents integers from −t to −1 by using slices from the slice starting from −t/(2t) to the slice starting from −1/(2t) counterclockwise from top.

The right half plane of the circle group {T}, which handles 0 and positive numbers (non-negative numbers), represents integers from 0 to t−1 by using slices from the slice starting from 0/(2t) to the slice starting from t−1/(2t) in the counterclockwise direction from bottom.

In the TLWE ciphertext ca, integer values are assigned to respective sections of 1/(2t) obtained by dividing the circle group {T1.

A value of a plaintext integer a TLWE ciphertext can take is 2t values obtained by dividing the value region 0 to 1, from −t to t−1, in which t−1 is the maximum integer that can be recorded in one TLWE ciphertext and −t is the minimum integer that can be recorded in one TLWE ciphertext.

As for the TLWE ciphertext ca, an offset of 1/(4t) is added to the plaintext as described above, so that plaintexts corresponding to an integer 0, for example, are distributed around 0+1/(4t) of the circle group {T} with an error added thereto. Accordingly, the position of 0 on the circle group {T} can be set to the boundary between the integer 0 and the integer −1. The section for 0 is assumed as a range on the circle group {T} from 0 to 1/(2t), and the circle group {T} is divided into slices in such a manner that blocks are adjacent to the block from 0 to 1/(2t) in turn.

In the state where no offset is added illustrated in FIG. 6B, 0 (1) on the circle group {T} is within the slice from −1/(4t) to 1/(4t) (one slice corresponds to a noise added to a plaintext around 0).

As illustrated in FIG. 6A, by adding the offset, the integer 0 can be associated with the slice (0/2t) starting from 0 on the circle group {T}, and at the same time the plaintext can be placed at the center of the slice. Other slices start from X/2t (where X is a plaintext integer).

As a result, 0 on the circle group is associated to refer to the 0th degree term in a test vector polynomial used when a process using bootstrapping is performed, and thus adding the offset in the above-described manner has an advantage that the order of coefficients is natural and easy to see. However, adding the offset in the above-described manner is in principle not a mandatory requirement. Accordingly, different offsets can be used by performing appropriate adjustment by a test vector, preprocessing, postprocessing, or the like.

In FIG. 6A, the plaintext with the offset added thereto is located at the center of each slice (for example, the slice starting from 1/(2t)) with an error range of ±1/(4t). At this time, the average of the normal distribution is, for example, 1/(2t)+1/(4t), and plaintexts are distributed within the error range of ±1/(4t) in most cases. The plaintexts are thus distributed at the center of the slice starting from 1/(2t).

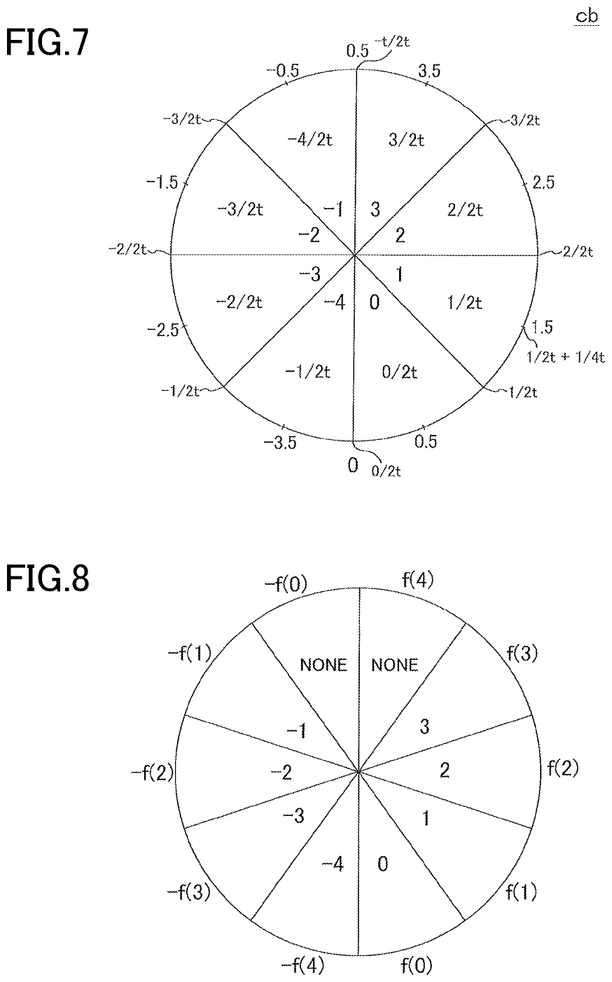

Although the plaintext with the offset added thereto is illustrated only in the slice of 1/(2t) in FIG. 6A, this illustration is merely an example. A plaintext with an offset added to a value serving as a starting point is present in every slice. The same applies to FIG. 7 described later.

As described above, the ciphertext in FIG. 6A divides the right half plane of the circle group {T} into t and the left half plane into t. The right half plane of the circle group {T}corresponds to 0 and positive plaintext integers (0 to t−1), and the left half plane corresponds to negative plaintext integers (−1 to −t). The width of one block (slice) is 1/(2t).

Integer values are respectively assigned to the slices obtained by dividing the range from 0 to 1 (−1/2 to 1/2) of the circle group {T} into 2t and respectively starting from −t/(2t) to (t−1)/(2t).

Non-negative integers are assigned to slices starting from 0/(2t), 1/(2t), . . . , (t−3)/(2t), (t−2)/2t, and (t−1)/(2t) of the right half plane, respectively. Negative integers are assigned to slices starting from −t/(2t), −(t−1)/(2t), −(t−2)/(2t), . . . , −1/(2t) of the left half plane, respectively.

These slices are each centered at a value obtained by adding the offset of +1/(4t) to the value serving as the starting point. The offset of 1/(4t) corresponds to half of the slice width of 1/(2t). When the offset of 1/(4t) is included in integer representation, it can be represented as an offset of +0.5 for convenience.

As illustrated in FIG. 6A, when 2t=8 (t=4) and the range of the circle group is divided into eight, integers from 0 to 3 (=t−1) can be represented by the right half plane of the circle group {T}, and integers from −4 (=−t) to −1 can be represented by the left half plane. That is, the entire ciphertext can represent the integers −4, −3, −2, −1, 0, 1, 2, and 3.

These integer values are assigned to sections obtained by dividing the range of the circle group {T} into 2t=8 and starting from −4/(2t), −3/(2t), −2/(2t), −1/(2t), 0/(2t), 1/(2t), 2/(2t), and 3/(2t), respectively. Integers are successively assigned counterclockwise from the region starting from 1/2.

Considering the above-described offset of 0.5, the slice starting from 1/(2t) on the right half plane, for example, is the slice centered on 1.5/(2t), and the slice starting from −4/(2t) on the left half plane, for example, is the slice centered on −3.5/(2t). Integers represented to include the offset are −3.5, −2.5, −1.5, −0.5, 0.5, 1.5, 2.5, and 3.5 counterclockwise from top.

The range of integer values that can be recorded in a TLWE ciphertext can be made larger by making the value of t larger and dividing the circle group {T} more finely. However, when the circle group is divided too finely, there is a problem that the range of the error to be added to the plaintext becomes too small, thus lowering the strength of encryption. This point will be described later.

The value of the offset, 1/(4t), is merely an example, and is not limited thereto. In accordance with the offset value, it is necessary to adjust a polynomial and parameters.

Methods are described that calculate an odd function and an even function by using the circle group in FIG. 6A in which division is made into even number of regions.

Method 1 and its application and Method 2 that calculate an odd function and Methods 3 and 4 that calculate an even function are described below.

[Odd Function]

When a function ƒ(x) for a real number x satisfies ƒ(−x)=−ƒ(x), the function is defined as an odd function.

The encryption processing apparatus 1 sets an odd function to be calculated to ƒ(x) and obtains a new ciphertext having a plaintext of ƒ(a+0.5) from the value a of the plaintext integer of the TLWE ciphertext ca.

<Method 1>

This method corresponds to (a-1) in FIG. 2A.

The encryption processing apparatus 1 performs the first Bootstrapping for the TLWE ciphertext ca by using a function that is a univariate polynomial (univariate function) F1_{id}(X) when coefficients are seen from the higher order to the lowest order and vice versa

$$F {1}_{id} ( X ) = {\sum }_{k = 0}^{t - 1} ( \frac{k}{2 t} + \frac{1}{4 t} ) {\sum }_{l = 0}^{n / t - 1} {X}^{\frac{n}{t} k + l}$$

to obtain the TLWE ciphertext cb illustrated in FIG. 7 in which values on the left half plane of the circle group {T} handling negative numbers (corresponding integer values) are inverted.

Gate Bootstrapping includes BlindRotate, SampleExtract, and Public Key Switching.

For an operation of a univariate function for an encrypted integer value, a method can be used which is obtained by expanding Gate Bootstrapping in Chillotti et al., 2020. This method is described in “Bootstrapping in FHEW-like Cryptosystems, Daniele Micciancio and Yuriy Polyakov Duality technologies Feb. 23, 2020”. The disclosed method does not set coefficients of a test vector to a constant μ, but sets the result of the function, thereby obtaining a different result depending on the value of the TLWE ciphertext.

FIG. 7 illustrates to which integer value in the original TLWE ciphertext ca a value on a circle group corresponding to a plaintext of the TLWE ciphertext cb corresponds, or the correspondence between a position on the circle group as a plaintext of the TLWE ciphertext ca and an integer value as the TLWE ciphertext cb. As illustrated in FIG. 7, in the TLWE ciphertext cb, the order of values on the left half plane that is a region used as negative values is inverted from that in the TLWE ciphertext ca, as a result of the first Bootstrapping performed for the TLWE ciphertext ca by using the polynomial F1_{id}(X).

For input of a ciphertext of a non-negative integer from 0 to t−1, the polynomial F1_{id}(X) outputs a ciphertext of the same non-negative integer from 0 to t−1 and adds an offset of 0.5 to the plaintext. For input of a ciphertext of a negative integer from −t to −1, the polynomial F1_{id}(X) outputs a ciphertext of an integer from −1 to −t and adds an offset of 0.5 to the plaintext integer.

As illustrated in FIG. 6A, the width of a slice to which one integer corresponds in the TLWE ciphertext ca is 1/(2t). Thus, adding the offset of 0.5 to the plaintext integer a in the TLWE ciphertext cb is equivalent to adding an offset of 1/(4t) to the plaintext real number a/(2t), for example. Integer representation that includes the offset of +1/(4t) added to the plaintext is represented as +0.5.

In a case where a plaintext is located on the right half plane of the circle group {T} in FIG. 6A (the plaintext is a non-negative number), the plaintext integer of the TLWE ciphertext cb remains within the same slice (region) of the circle group {T} as illustrated in FIG. 7 as a result of the above-described process using the polynomial F1_{id}(X). Meanwhile, in a case where a plaintext is a negative number from −t to −1 and located on the left half plane of the circle group {T}, the order of the plaintext integers of the TLWE ciphertext cb is inverted on the circle group {T} as illustrated in FIG. 7 as a result of the above-described process.

For example, in a case where the plaintext integer a in the TLWE ciphertext ca is −1 as illustrated in FIG. 6A, this value as a value on the circle group {T} is located in the section from −1/(2t) to 0. Therefore, the term of the leading block in the polynomial F_{id}(X) appears as the last term with the sign reversed. The plaintext of the TLWE ciphertext cb after the first Bootstrapping thus becomes −1/2+1/(4t) as a value on the circle group and −t as an integer.

In a case where the plaintext integer a in the TLWE ciphertext ca is −t, this value as a value on the circle group {T} is −t/2t+1/(4t)=−1/2+1/(4t) and located in the closest block to −1/2 on the left half plane. Since the result of sign reversal of the term of the last block in the polynomial F1_{id}(X) is obtained as the TLWE ciphertext cb after the first Bootstrapping, the plaintext of the TLWE ciphertext cb becomes−1/(4t) as a value on the circle group, that is,−1 as an integer.

On the right half plane in FIG. 7, integers from 0 to t-1 are assigned to slices from 0/(2t) to 4/(2t) counterclockwise from bottom, and the order of plaintext integers is not changed from that in FIG. 6A.

Meanwhile, on the left half plane, integers from −1 to −t are assigned to slices from −t/(2t) to−1/(2t) counterclockwise from top, so that the order of plaintext integers is inverted from that in FIG. 6A.

In the ciphertext cb illustrated in FIG. 7, integers are−1, -2,−3, -4, 0, 1, 2, and 3 from top on the circle group {T}. Positive values and negative values are arranged continuously on the circle group {T}.

In FIG. 6A, in a case where the TLWE ciphertext ca is a ciphertext of−1, for example, the plaintext is located in the section from −1/(2t) to 0 on the circle group {T}.

As a result of the above process, in the TLWE ciphertext cb, the term of the leading block in the polynomial F1_{id}(X) appears as the last term with the sign reversed. Therefore, in FIG. 7, the plaintext of the TLWE ciphertext ca is −1/2+1/(4t) as a value on the circle group {T}.

Although this plaintext corresponds to the integer −t(=−4) in FIG. 6A,−1 that is the original plaintext integer is assigned as the plaintext integer in the TLWE ciphertext cb illustrated in FIG. 7.

In FIG. 6A, in a case where the TLWE ciphertext ca is a ciphertext of −t, for example, the plaintexts are distributed around −t/(2t)+1/(4t) on the circle group {T} (is slightly larger than−1/2). The plaintexts are thus located in the closest section to−1/2 on the circle group {T}.

As a result of the above process, in the TLWE ciphertext cb, the term of the last block in the polynomial F1_{id}(X) appears with the sign reversed. Therefore, in FIG. 7, the plaintext of the TLWE ciphertext ca is−1/(2t)+1/(4t) as a value on the circle group {T}. Although this plaintext corresponds to the integer−1 in FIG. 6A, −t(=−4) is assigned as the plaintext integer of the original TLWE ciphertext ca in the TLWE ciphertext cb illustrated in FIG. 7.

As described above, in a case where the integer value to be assigned is made the same before and after bootstrapping by the test vector polynomial Fid(X), it can be interpreted that in the TLWE ciphertext cb, the order of integer values arranged on the left half plane is inverted.

When the above description is generalized, the plaintext of the TLWE ciphertext ca, which is a non-negative number, becomes a/(2t)+1/(4t) in the TLWE ciphertext cb, and the plaintext integer remains a.

Meanwhile, the plaintext of the TLWE ciphertext ca, which is a negative number, becomes −(t+1+a)/(2t)+1/(4t) in the TLWE ciphertext cb.

This result is also found from the fact that, when attention is paid to only the numerator of the plaintext, in a case where the plaintext integer a is−1, −(t+1+a)=−{t+1+(−1)}=−t, and in a case where the plaintext integer a is −t, −(t+1+a)=−{t+1+(−t)}=−1. It is confirmed that this result matches the result when the plaintext of the TLWE ciphertext cb is regarded as an integer.

As a result of this process, an offset is added to the plaintext by the term of 1/(4t) added to the terms in the polynomial. Therefore, similarly to the TLWE ciphertext ca in FIG. 6A, the position of 0 on the circle group becomes the boundary between slices also in the TLWE ciphertext cb in FIG. 7.

As described above, in a case where the plaintext is a negative number, the plaintext to which an integer is assigned is changed. In other words, assuming that the plaintext of the TLWE ciphertext cb when being seen as an integer symbol is the same value as the integer of the ciphertext ca, the correspondence between slices for plaintexts of the TLWE ciphertext cb and integers is different from that for the TLWE ciphertext ca. As for this correspondence, the order of the slices for plaintexts on the circle group is not changed between the ciphertext ca and the ciphertext cb. However, on the left half plane to which negative values are assigned, the order of plaintext integers respectively assigned to plaintexts is inverted.

Since the order is simply inverted, the order returns to the original order by performing bootstrapping by the test vector polynomial Fid(X) twice. That is, when a plaintext is seen as a value on the circle group {T}, it returns to the same slice. However, since the error added to the plaintext has been sufficiently reduced by the properties of bootstrapping, this process can be used as bootstrapping when the entire plane of the circle group is used.

In FIG. 7 in which t=4 (2t=8), the above-described offset of 0.5 has been added to the plaintext of the ciphertext. Therefore, the plaintexts located at the centers of slices are −3.5/(2t),−2.5/(2t), −1.5/(2t), −0.5/(2t), 0.5/(2t), 1.5/(2t), 2.5/(2t), and 3.5/(2t) from top (1/2) of the circle group {T} in the left direction (counterclockwise), respectively.

To these slices, −1, −2, −3, −4, 0, 1, 2, and 3 are assigned counterclockwise as the plaintext integers of the TLWE ciphertext ca that has been used as the input for generating the TLWE ciphertext cb, respectively. Integers represented to include the offset of 0.5 are −0.5, −1.5, −2.5, −3.5, 0.5, 1.5, 2.5, and 3.5 from top on the circle group {T}.

Next, the encryption processing apparatus 1 extracts, from the result of an operation of the function ƒ(x), only values in a case where x is non-negative and creates the following polynomial F1_{ƒ(X).}

$$F {1}_{f} ( X ) = {\sum }_{k = 0}^{t - 1} ( \frac{f ( k + 0.5 )}{2 t} + \frac{1}{4 t} ) {\sum }_{l = 0}^{n / t - 1} {X}^{\frac{n}{t} k + l}$$

The encryption processing apparatus 1 then performs the second Bootstrapping using this polynomial Flf(X) for the TLWE ciphertext cb to obtain the TLWE ciphertext cc.

In a case where the TLWE ciphertext cb is non-negative, that is, the plaintext integer a is 0, 1, 2, . . . , the plaintexts are located on the right half plane (0 to 0.5) of the circle group.

Therefore, the TLWE ciphertext cc is obtained in which the signs are not reversed and which has values of ƒ(0.5), ƒ(1/5), ƒ(2.5), . . . as plaintexts.

Meanwhile, in a case where the TLWE ciphertext cb is negative, that is, the plaintext integer a is −1, −2, −3, . . . , they are arranged in the section from 0.5 to 1 in that order. Therefore, the TLWE ciphertext cc is obtained in which the signs are reversed and which has values of−ƒ(0.5),−ƒ(1/5),−ƒ(2.5), . . . as plaintexts.

If ƒ(x) is an odd function, plaintexts φ(cc) of the TLWE ciphertext cc obtained to correspond to a=−1, −2, −3, . . . match ƒ(−0.5), ƒ(−1.5), ƒ(−2.5), . . . , respectively.

That is, together with the non-negative example described above, this example shows that the TLWE ciphertext cc satisfying φ(cc)=ƒ(a+0.5) and corresponding to the operation result of the odd function was able to be obtained.

<Application of Method 1>

Method 1 can be applied to all cases of calculating a linear function and corresponds to (a−2) in FIG. 2A.

First, it is assumed that an odd function ƒ(x)=mx (m is a real number). A general formula of linear functions can be presented as ax+b in most cases. However, only if b=0, the linear function becomes an odd function.

By using Method 1, φ(cc)=ƒ(a+0.5)=am+0.5m can be calculated. As an additional step to Method 1, a trivial ciphertext (0, m′-0.5m) is added to the TLWE ciphertext cc, and the result is defined as a TLWE ciphertext cd. Since consideration is made while the function ƒ, in particular, m is fixed here, m is a constant.

Then, φ(cd)=φ(cc+(0, m′-0.5m))=φ(cc)+m′−0.5m=(am+0.5m)+m′−0.5m=am+m′.

Thus, linear functions can be calculated for general purpose.

<Method 2>A method of calculating a general odd function is described. This method corresponds to (a-3) in FIG. 2A.

Since the linear function described above is also an odd function if the intercept is 0, they can be calculated in the following manner.

A test vector for the first Bootstrapping is changed to the following polynomial F1′_{id}(X).

$$F {1}_{id}^{′} ( X ) = {\sum }_{k = 0}^{t - 1} ( \frac{k}{2 ( t + 1 )} + \frac{1}{4 ( t + 1 )} ) {\sum }_{l = 0}^{n / t - 1} {X}^{\frac{n}{t} + l}$$

The polynomial F1′_{id}(X) is different from F1_{id}(X) in Method 1 and is slightly larger in the denominator. As a result, in the TLWE ciphertext cb in FIG. 8 obtained by the first Bootstrapping using the polynomial F1′_{id}(X), slices become smaller than those in FIG. 7.

Since the denominator simply becomes larger, plaintexts come close to 0 slightly in a case where the plaintexts are located on the right half plane of the circle group (i.e., are positive numbers), as illustrated in FIG. 8. In a case where the plaintexts are located on the left half plane (i.e., are negative numbers, that is, from −t to−1), the order of plaintext integers is inverted from FIG. 6A, and the plaintexts come close to 0.

For example, in a case where a is−1, it is in the section from −1/(2t) to 0 as a value on the circle group. Accordingly, the term of the leading block in F1′_{id}(X) appears as the last term with the sign reversed, and therefore the plaintext of a TLWE ciphertext after the first Bootstrapping is −(t-1)/{2(t+1)}−1/{4(t+1)}=−t/{2(t+1)}+1/{4(t+1)} as a value on the circle group and −t as an integer (the range between the minimum value and the maximum value that can be retained becomes larger because the denominator becomes larger, so that values from −(t+1) to t can be retained). Further, in a case where a is −t, it is −t/2t+1/(4t)=−1/2t+1/(4t) as a value on the circle group and is in the closest block to −1/2. That is, the term of the last block in F1′i_{d}(X) with the sign reversed is obtained as a TLWE ciphertext after the first Bootstrapping, and therefore the plaintext becomes −1/{4(t+1)}, i.e., −1 as an integer.

Generalizing the above description, in a case where a is positive, the plaintext of the TLWE ciphertext cb becomes a/{2(t+1)}+1/{4(t+1)}, and its integer remains a.

In a case where a is negative, the plaintext of the TLWE ciphertext cb becomes −(t+1+a)/{2(t+1)}+1/{4(t+1)}, and its integer becomes −(t+1+a).

Since the denominator becomes larger and the number of slices is increased by one on each of right and left sides, the coordinate on the circle group is changed. However, when the plaintext is seen as an integer, the symbol thereof is the same as that in Method 1.

Further, in the result of this process, an offset is added due to the term of 1/(4(t+1) that has been added to a term in a polynomial, and the position of 0 on the circle group matches the boundary between the slices as in FIG. 8.

The encryption processing apparatus 1 extracts, from the result of the operation of the function ƒ(x) to be processed, values in a case where x is non-negative to create a polynomial F1_{ƒ′(X).}

$$F {1}_{f}^{′} ( X ) = {\sum }_{k = 0}^{t} ( \frac{f ( k )}{2 t} + \frac{1}{4 t} ) {\sum }_{l = 0}^{n / t + 1 - 1} {X}^{\frac{n}{t + 1} k + l}$$

The encryption processing apparatus 1 performs Bootstrapping for the TLWE ciphertext cb by using the polynomial Flf(X) as a test vector thus created, thereby obtaining the TLWE ciphertext cc.

The function ƒ(x) is a function that uses an integer as an argument and obtains an integer.

Then, as illustrated in FIG. 8, in a case where the TLWE ciphertext cb is non-negative, that is, the plaintext integer a is 0, 1, 2, . . . , these integers are located on the right part (from 0 to 0.5) of the circle group. Therefore, the ciphertext cc is obtained which has ƒ(0), ƒ(1), ƒ(2), . . . as the plaintext without sign reversal.

Further, as illustrated in FIG. 8, in a case where the TLWE ciphertext cb is negative, that is, the plaintext integer a is −1, −2, −3, . . . , these values are arranged in the section from 0.5-1/2(t+1) to 1. Therefore, the ciphertext cc is obtained in which the signs are reversed and which has−ƒ(1),−ƒ(2),−ƒ(3), . . . , as the plaintext.

If ƒ(x) is an odd function,−ƒ(x)=ƒ(−x).

Therefore, this matches p(cc)=ƒ(a).

Next, a method of calculating an even function using a circle group in which division is made into odd number of regions is described.

When a function ƒ(x) for areal number x satisfies ƒ(−x)=ƒ(x), the function ƒ(x) is defined as an even function.

<Method 3>

This method corresponds to (b-1) in FIG. 2B.

The encryption processing apparatus 1 performs the third Bootstrapping for the TLWE ciphertext ca by using the following polynomial F1_{abs}(X)

$$F {1}_{abs} ( X ) = {\sum }_{k = 0}^{t - 1} ( \frac{k}{2 ( t + 1 )} + \frac{1}{4 ( t + 1 )} - \frac{1}{4} ) {\sum }_{t = 0}^{n / t - 1} {X}^{\frac{n}{t} k + l}$$

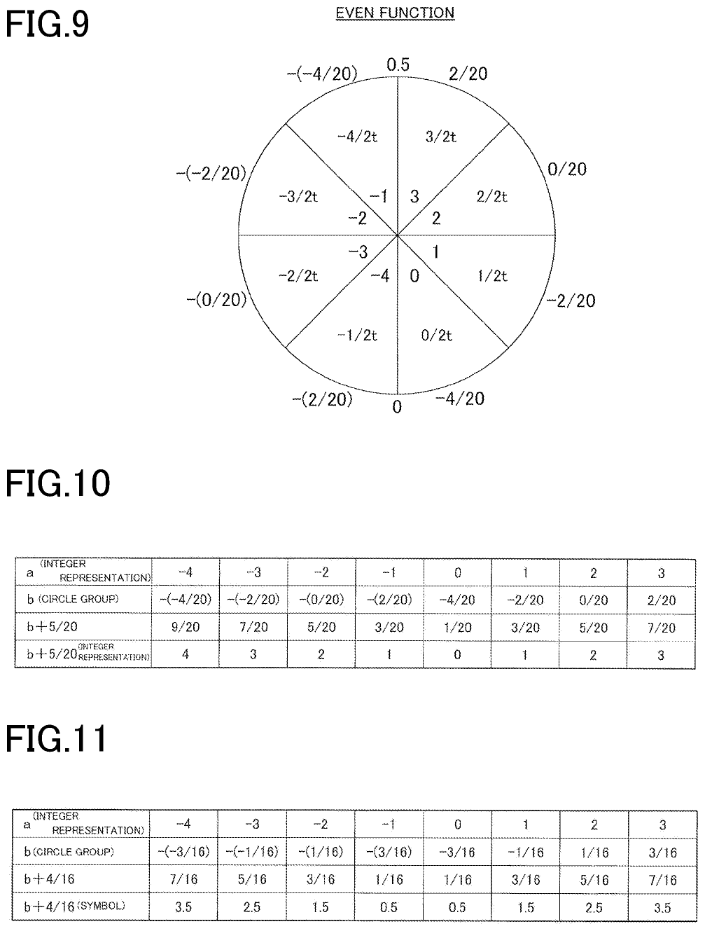

as a test vector, thereby obtaining the new TLWE ciphertext cb (FIG. 9).

In the TLWE ciphertext cb, conversion illustrated in FIGS. 9 and 10 is performed.

FIG. 10 is an explanatory diagram of transition of a value of a ciphertext in the first example (even function) and represents the plaintext of the TLWE ciphertext cb obtained as a result of the third Bootstrapping.

In FIG. 9, numerical values on the right half plane are arranged in the same order as that of coefficients in a test vector polynomial, and numerical values on the left half plane are arranged with the sign reversed while the order thereof is inverted.

The following description is based on a case where t=4.

In a case where the plaintext integer a is non-negative, the plaintext is located on the right half plane of the circle group {T}. Thus, when the denominators in k/{2(t+1)}+1/{4(t+1)}−1/4 in F_{abs}(X) are set to 4x(t+1)=20, 2k/{4(t+1)}+1/{4(t+1)}−(t+1)/{4(t+1)1. From this, {2k+1−(t+1)}/20=(2k-4)/20.

Since t=4, the plaintext b of the TLWE ciphertext cb is not an integer and is−4/20 for a=0, −2/20 for a=1, . . . , when seen as a value on the circle group, as illustrated in FIG. 9.

As a result of the third Bootstrapping by F_{abs}(X), in a case where the plaintext integer a is negative, it is obtained with the sign reversed in a direction from 0.5 to 1. Thus, the plaintext b of the ciphertext cb is 4/20 for a=−4, which is the value for a=0 with the sign reversed, and is−2/20 for a=−1, which is the value for a=3 with the sign reversed, as illustrated in FIG. 9.

As illustrated in FIG. 10, the value of the plaintext b on the circle group is
4/20 when the plaintext integer a is −4,
2/20 when the plaintext integer a is −3,
0/20 when the plaintext integer a is −2,
2/20 when the plaintext integer a is −1,
4/20 when the plaintext integer a is 0,
−2/20 when the plaintext integer a is 1,
0/20 when the plaintext integer a is 2, and
2/20 when the plaintext integer a is 3.

The encryption processing apparatus 1 adds a trivial ciphertext (0, 1/4) to the TLWE ciphertext cb to obtain the TLWE ciphertext cc. Since 1/4 is written as 5/20 by using the common denominator to the above value, 5 is added to the numerator of the plaintext b of the TLWE ciphertext cb, so that all the plaintexts b are placed on the right half plane.

As illustrated in FIG. 10, the value of b+5/20 on the circle group is
9/20 when the plaintext integer a is −4,
7/20 when the plaintext integer a is −3,
5/20 when the plaintext integer a is −2,
3/20 when the plaintext integer a is −1,
1/20 when the plaintext integer a is 0,
3/20 when the plaintext integer a is 1,
5/20 when the plaintext integer a is 2, and
7/20 when the plaintext integer a is 3.

Since the denominator of the plaintext b is 20, and the numerator increases by 2, the TLWE ciphertext cc can be regarded as a non-negative ciphertext in a case of dividing the entire circle group {T} into 10 (dividing the right half plane into t+1=5) and using it.

Assuming that the circle group is divided into 10, the integer representation of b+5/20 that is the plaintext of the TLWE ciphertext cc is as follows, as illustrated in FIG. 10.
When the plaintext integer a is −4, 9/20=4.5/10 >>4.
When the plaintext integer a is −3, 7/20=3.5/10 >>3.
When the plaintext integer a is −2, 5/20=2.5/10 >>2.
When the plaintext integer a is −1, 3/20=1.5/10 >>1.
When the plaintext integer a is 0, 1/20=0.5/10 >>0.
When the plaintext integer a is 1, 3/20=1.5/10 >>1.
When the plaintext integer a is 2, 5/20=2.5/10 >>2.
When the plaintext integer a is 3, 7/20=3.5/10 >>3.

As for the order, the value of b+5/20 becomes larger with increase in the distance from a=0 in the positive and negative directions, and it can be said that an absolute value function has been calculated. That is, p(cb)=Ial, where is the symbol for absolute value.

In addition, since the plaintext of the TLWE ciphertext cc only uses the right half plane of the circle group {T}, the encryption processing apparatus 1 can evaluate any univariate function by using the method in Micciancio and Polyakov, 2020.

The encryption processing apparatus 1 performs the fourth Bootstrapping for the TLWE ciphertext cc by using a function

$$F {1}_{f}^{′} ( X ) = {\sum }_{k = 0}^{t} ( \frac{f ( k )}{2 t} + \frac{1}{4 t} ) {\sum }_{l = 0}^{n / t + 1 - 1} {X}^{\frac{n}{t + 1} k + l} ,$$

where the function ƒ(x) is a function that uses as an argument and obtains an integer. The ciphertext cd is thus obtained.

Since the TLWE ciphertext cb only uses the right half plane as described above, φ(cc)=ƒ(φ(cb)) is established. When φ(cb)=|a|is substituted, φ(cc)=ƒ(|a|) is obtained, where is the symbol for absolute value.

If ƒ(x) is an even function, ƒ(x)=ƒ(−x), that is, ƒ(x)=ƒ(|x|) is always established in a case where x is a real number. Thus, the above result matches φ(cc)=ƒ(a).

<Method 4>

This method corresponds to (b-2) in FIG. 2B.

Also in a case of an even function, if x in an even function ƒ(x) is shifted by 0.5 and ƒ(x+0.5) is to be obtained by calculation, it is no longer necessary to make the denominator of the plaintext of the intermediate TLWE ciphertext cb larger.

FIG. 11 is an explanatory diagram of transition of a value of a ciphertext in the first example (even function) and represents the plaintext of the TLWE ciphertext cb obtained as a result of Bootstrapping by a polynomial F1′abs(X).

The encryption processing apparatus 1 performs the third Bootstrapping for the TLWE ciphertext ca by using the following polynomial F1′_{abs}(X)

$$F {1}_{abs}^{′} ( X ) = {\sum }_{k = 0}^{t - 1} ( \frac{k}{2 t} + \frac{1}{4 t} - \frac{1}{4} ) {\sum }_{l = 0}^{n / t - 1} {X}^{\frac{n}{t} k + l}$$

as a test vector, thereby obtaining the TLWE ciphertext cb.

As illustrated in FIG. 11, the value of the plaintext b on the circle group is
(−3/16) when the plaintext integer a is −4,
(−1/16) when the plaintext integer a is −3,
1/16 when the plaintext integer a is −2,
3/16 when the plaintext integer a is −1,
3/16 when the plaintext integer a is 0,
−1/16 when the plaintext integer a is 1,
1/16 when the plaintext integer a is 2, and
3/16 when the plaintext integer a is 3.

The encryption processing apparatus 1 adds a trivial ciphertext (0, 1/4) to the TLWE ciphertext cb. Since 1/4 is written as 4/16 by using the common denominator to the above value, 4 is added to the numerator of the plaintext b of the TLWE ciphertext cb, so that all the plaintexts b are placed on the right half plane.

As illustrated in FIG. 11, the value of b+4/16 on the circle group is
7/16 when the plaintext integer a is −4,
5/16 when the plaintext integer a is −3,
3/16 when the plaintext integer a is −2,
1/16 when the plaintext integer a is −1,
1/16 when the plaintext integer a is 0,
3/16 when the plaintext integer a is 1,
5/16 when the plaintext integer a is 2, and
7/16 when the plaintext integer a is 3.

Since the denominator of the plaintext b is 16, and the numerator increases by 2, the TLWE ciphertext cc can be regarded as a non-negative ciphertext in a case of dividing the entire circle group {T} into ten (dividing the right half plane into t+1=5) and using it.

Assuming that the circle group is divided into ten, the integer representation of b+4/16 that is the plaintext of the TLWE ciphertext cc is as follows, as illustrated in FIG. 11.

When the plaintext integer a is −4, 7/16=3.5/8 >>3.5.

When the plaintext integer a is −3, 5/16=2.5/8 >>2.5.

When the plaintext integer a is −2, 3/16=1.5/8 >>1.5.

When the plaintext integer a is −1, 1/16=0.5/8 >>0.5.

When the plaintext integer a is 0, 1/16=0.5/8 >>0.5.

When the plaintext integer a is 1, 3/16=1.5/8 >>1.5.

When the plaintext integer a is 2, 5/16=2.5/8 >>2.5.

When the plaintext integer a is 3, 7/16=3.5/8 >>3.5.

It is found from FIG. 11 that the absolute value function has been calculated by turning back at the position of 0 on the circle group. That is, it can be said that p(cc)=|a+0.5|, where |is the symbol for absolute value.

The encryption processing apparatus 1 performs the fourth Bootstrapping for the TLWE ciphertext cc by using the above polynomial F1′_{ƒ(X) as a test vector to obtain the TLWE ciphertext cd. This case is the same as the above case in using the right half plane only.}

Then, φ(cd)=ƒ(|a+0.5|) is obtained. If ƒ(x) is an even function, ƒ(x)=ƒ(−x)=ƒ(|x|) is satisfied, and therefore φ(cd)=ƒ(a+0.5).

[Second Example: Division into Odd Number of Regions]

In the first example, a case of dividing a circle group into an even number of regions has been described.

In a second example described below, calculation of an odd function and calculation of an even function are described in a case where the circle group is divided into an odd number of regions.

In a case where the entire circle group is used, overflow in homomorphic addition is simply processed as a remainder at the maximum value of +1. For example, a case is considered in which the entire circle group is divided into seven regions and integer values from 0 to 6 are used. In this case, when homomorphic addition of 4+6 is performed, the result is originally 10. However, since this result value reaches a position beyond a position corresponding to one round of the circle group, 7 as the dividing number of one round when being decoded is subtracted from the result, i.e., 10-7 is calculated, so that 3 is obtained as the result. That is, simply performing homomorphic addition results in calculation of (a+b)mod(t), where mod(t) represents a remainder of division by t. Similarly, performing homomorphic subtraction is equivalent to calculation of (a-b)mod(t).

In general, a set of remainders each obtained by division of an integer by an integer has properties of a residue class group. In particular, a set of remainders each obtained by division of an integer by a prime number is known as having properties of a “field” and is referred to as a “finite field”.

The finite field has various easy-to-handle features. For example, an inverse element is defined for every element in the “finite field”. This fact means that division between desired elements can be replaced with multiplication between inverse elements. In general, division requires complicated processing and, also when being computed by a computer, requires more computation time than others in the four arithmetic operations. If such division can be computed only by multiplication, it is greatly advantageous.

However, the method described in the first example can only divide the entire circle group into an even number of regions, and prime numbers other than 2 are all odd numbers.

Therefore, it is difficult to efficiently calculate a desired function of the finite field.

On the other hand, in the second example, an encrypted finite field is efficiently handled while both using the entire circle group and dividing the circle group into an odd number, especially a prime number (i.e., an odd prime number) of regions are achieved. A desired function of the finite field can thus be calculated.

Although the method in the second example is suitable for a case where the circle group is divided into an odd number of regions, it can also be applied to a case where the circle group is divided into an even number of regions.

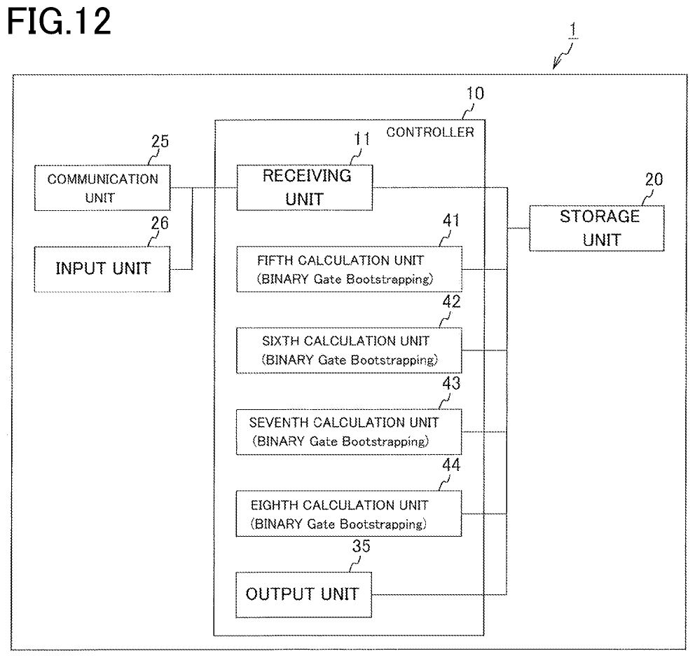

FIG. 12 is an explanatory diagram of a functional configuration of an encryption processing apparatus of the second example.

Configurations identical to those in FIG. 1 are denoted by like reference signs and explanations thereof are omitted.

The encryption processing apparatus 1 in FIG. 12 includes the controller 10, the storage unit 20, the communication unit 25, and the input unit 26, as in FIG. 1.

The controller 10 includes the receiving unit 11, a fifth Bootstrapping unit (calculation unit) 41, a sixth Bootstrapping unit (calculation unit) 42, a seventh Bootstrapping unit (calculation unit) 43, an eighth Bootstrapping unit (calculation unit) 44, and the output unit 35.

In an operation of an odd function as a univariate function, the fifth Bootstrapping unit 41 performs fifth Gate Bootstrapping for an input ciphertext received by the receiving unit 11.

The sixth Bootstrapping unit 42 performs sixth Gate Bootstrapping for the ciphertext output from the fifth Bootstrapping unit 41.

In an operation of an even function as a univariate function, the seventh Bootstrapping unit 43 performs seventh Gate Bootstrapping for the input ciphertext received by the receiving unit 11.

The eighth Bootstrapping unit 44 performs eighth Gate Bootstrapping for the ciphertext output from the seventh Bootstrapping unit 43.

The fifth Bootstrapping unit 41, the sixth Bootstrapping unit 42, the seventh Bootstrapping unit 43, and the eighth Bootstrapping unit 44 are arithmetic processing units that implement Gate Bootstrapping processes by software.

At least one of the receiving unit 11, the fifth Bootstrapping unit 41, the sixth Bootstrapping unit 42, the seventh Bootstrapping unit 43, the eighth Bootstrapping unit 44, and the output unit 35 may be implemented by hardware.

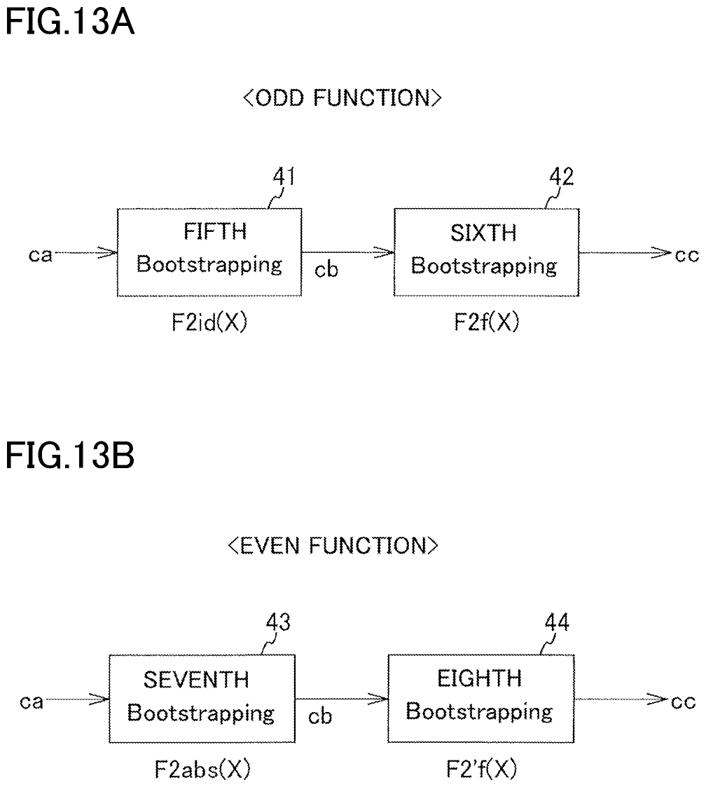

FIGS. 13A and 13B are explanatory diagrams of operation processes based on the functional configuration in FIG. 12.

The encryption processing apparatus 1 performs an operation of an odd function and an operation of an even function for an Integer-wise type TLWE ciphertext.

The TLWE ciphertext ca is a ciphertext of the plaintext integer a for which the operation of an odd function and the operation of an even function are to be performed.

In FIG. 13A, the encryption processing apparatus 1 performs an operation of an odd function as a univariate function.

The encryption processing apparatus 1 inputs the TLWE ciphertext ca to the fifth Bootstrapping 41 and performs the fifth Bootstrapping using a polynomial F2id(X) as a test vector, thereby obtaining the TLWE ciphertext cb.

The encryption processing apparatus 1 inputs the TLWE ciphertext cb to the sixth Bootstrapping unit 42 and performs the sixth Bootstrapping using a polynomial F2ƒ(X) as a test vector, thereby obtaining the TLWE ciphertext cc corresponding to the result of calculation of the odd function.

In FIG. 13B, the encryption processing apparatus 1 performs an operation of an even function as a univariate function.

The encryption processing apparatus 1 inputs the TLWE ciphertext ca to the seventh Bootstrapping unit 43 and performs the seventh Bootstrapping using a polynomial F2_{abs}(X) as a test vector, thereby obtaining the TLWE ciphertext cb.

The encryption processing apparatus 1 inputs the TLWE ciphertext cb to the eighth Bootstrapping unit 44 and performs the eighth Bootstrapping using a polynomial F2′_{ƒ(X) as a test vector, thereby obtaining the TLWE ciphertext cc corresponding to the result of calculation of the even function.}

[Odd Function]

First, a case of evaluating an odd function by using a circle group divided into an odd number of regions is described.

In the following description and the drawings related thereto, a case of t=2 may be exemplified without notice.

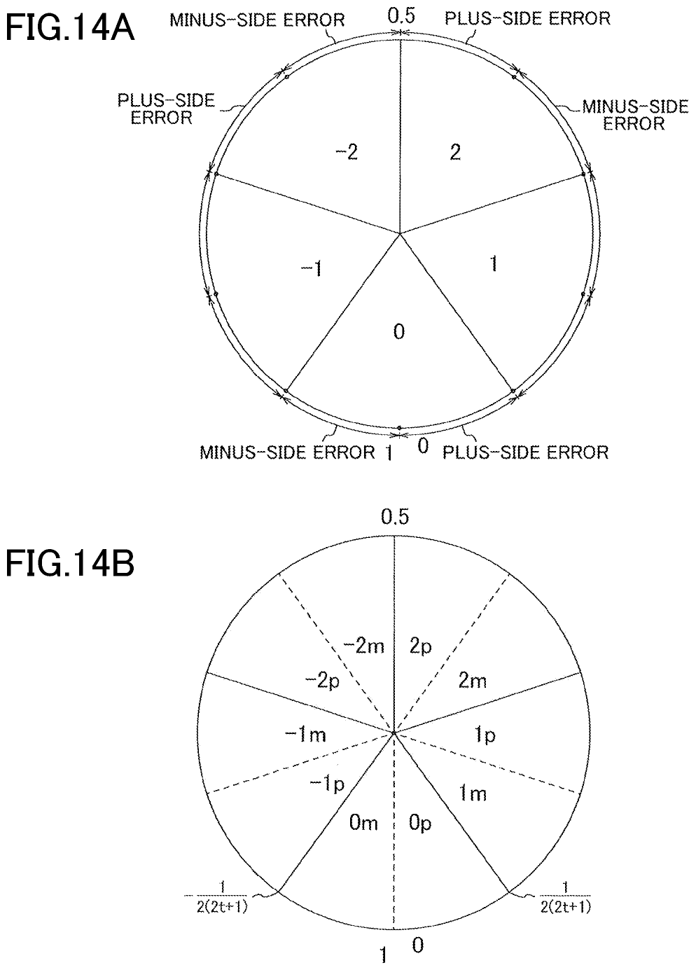

FIGS. 14A and 14B are explanatory diagrams of Integer-wise type TFHE in the second example and illustrate a circle group divided into an odd number of regions.

FIG. 14A illustrates a state where no offset is added to plaintexts.

In FIG. 14A, a region around 0 on the circle group {T} is associated with an integer 0.

Since the circle group {T} is divided into an odd number of regions, 0.5 (1/2) on the circle group {T} serves as the boundary between the maximum value t (=2) and the minimum value −t (=−2).

To the range from 0 to 0.5 (the right half plane) on the circle group {T}, coefficients in a test vector polynomial correspond in order from the lowest degree term to the highest degree term in turn. To the range from 0.5 to 1 (the left half plane), coefficients in the test vector polynomial with the sign reversed correspond in order from the lowest degree term to the highest degree term in turn.

As described above, FIG. 14A illustrates a case where a circle group is divided into an odd number of regions and no offset is added to plaintexts. In a case where a plus-side error is added around 0, the plaintext is located on the right half plane and corresponds to a coefficient of a lower degree term in the test vector polynomial. On the other hand, in a case where a minus-side error is added around 0, the plaintext is located on the left half plane and corresponds to a coefficient of a higher degree term in the test vector polynomial, whose sign has been reversed.

Therefore, in the slice corresponding to an integer 0, the coefficients are not continuous between the case where the plus-side error is added to the plaintext and the case where the minus-side error is added.

In Bootstrapping using the polynomial F2id(X) described later as a test vector, when the order of integers assigned to the left half plane is inverted, the integer 0 with a minus-side error added thereto is moved toward 0.5, but the integer 0 with a plus-side error added thereto remains around 0. Therefore, discontinuity becomes noticeable.

Meanwhile, when attention is paid to the 0.5 side in FIG. 14A, 0.5 on the circle group becomes the boundary between the slice to which an integer 2 is assigned and the slice to which an integer−2 is assigned.

In the slice to which the integer 2 is assigned and the slice to which the integer−2 is assigned, coefficients are continuous without crossing over 0.5 both in the case where a plus-side error is added to the plaintext and the case where a minus-side error is added.

That is, both in a case where the plus-side error is added to the integer 2 and a case where the minus-side error is added, the slices are located on the right half plane, and coefficients are continuous. Also, both in a case where the plus-side error is added to the integer−2 and a case where the minus-side error is added, the slices are located on the left half plane, and coefficients are continuous.

In order to eliminate discontinuity of coefficients around 0 on the circle group, an offset may be added to plaintexts in such a manner that the slice to which the integer 0 is assigned starts from the boundary between 0 and 1, as in division into an even number of regions in the first example.

However, in that case, the problem arises that the slice to which the integer 2 is assigned crosses over 0.5, resulting in discontinuity of coefficients between the case where the plus-side error is added to the integer 2 and the case where the minus-side error is added.

Therefore, in the second example in which the circle group is divided into an odd number of regions, the encryption processing apparatus 1 does not add an offset to plaintexts.

In place of adding an offset to plaintexts, the encryption processing apparatus 1 divides a slice to which an integer is assigned into two slices whose errors are in a plus-side error range and in a minus-side error range, respectively, as illustrated in FIG. 14B, and calculates an odd function and an even function by processing similar to that in division into an even number of regions.

In each slice in FIG. 14B, a value of the plaintext a (an integer value) of the TLWE ciphertext ca assigned thereto is indicated, where p added to a numeric character indicates that a plus-side error is added, and m added to a numerical character indicates that a minus-side error is added.

In relation to the description of FIG. 14B, the slice of 0p is located on the right half plane of the circle group, and the slice of 0m is located on the left half plane of the circle group.

The plaintext of the slice of 0p corresponds to the coefficient of the lowest degree term in a test vector polynomial, and the plaintext of the slice of 0m corresponds to the coefficient of the highest degree term in the test vector polynomial, with the sign reversed. Therefore, although both the slices correspond to the same integer 0, the coefficients are not continuous between the slice of 0p in which the plus-side error is added to the plaintext and the slice of 0m in which the minus-side error is added.

The slices of 2m and 2p are both located on the right half plane of the circle group, and the slices of −2m and −2p are both located on the left half plane. The plaintext of the slice of 2m and the plaintext of the slice of 2p respectively correspond to coefficients of terms of continuous (adjacent) degrees in the test vector polynomial. The same applies to the plaintext of the slice of −2m and the plaintext of the slice of −2p. That is, the coefficients are continuous between the slices of 2p and 2m that correspond to the same integer 2, and the coefficients are continuous between the slices of−2p and −2m that correspond to the same integer −2.

The encryption processing apparatus 1 sets a constant t that determines the size of each divided region of the circle group to a positive integer. By using this constant, the width of one block is set to 1/(2t+1). That is, the entire circle group is divided into (2t+1) blocks, where 2t+1 is an odd number.

Here, t is the maximum value of an integer that can be recorded in one TLWE ciphertext, and −t is the minimum value.

As illustrated in FIG. 14B, the range from −1/{2(2t+1)} to 1/{2(2t+1)} on the circle group is set to the section for 0, and blocks are arranged to be adjacent to that block.

This arrangement is for convenience of explanation. Even when another implementation is employed so as to shift an offset, for example, “the range from 0 to 1/(2t+1) is implemented as a block corresponding to 0”, it is possible to make sense by adjusting another parameter, a polynomial, or the like or performing adjustment in advance.

Next, the encryption processing apparatus 1 sets a system parameter in TFHE.

The maximum error is set to be less than ±1/{2(2t+1)}.

It is assumed that there is a TLWE ciphertext ca used as an argument of a function to be calculated.

The TLWE ciphertext ca has a real number a/(2t+1) corresponding to the integer a that cannot be known without a private key, as its plaintext.

This plaintext is a plaintext without an error, and a value with an error in the range determined as described above added thereto is actually stored as the plaintext.

The range in which the plaintext with the error is added is a range of a/(2t+1)±1/(4t+2), i.e., a range from (2a-1)/(4t+2) to (2a+1)/(4t+2).

The encryption processing apparatus 1 performs the fifth Bootstrapping for the TLWE ciphertext ca by using the following polynomial F2id(X) as a test vector, thereby obtaining the TLWE ciphertext cb.

$$F {2}_{id} ( X ) = {\sum }_{k = 0}^{2 t} ( \frac{k}{4 t + 2} + \frac{1}{8 t + 4} ) {\sum }_{l = 0}^{n / 2 t + 1 - 1} {X}^{\frac{n}{2 t + 1} k + l}$$

Bootstrapping includes BlindRotate, SampleExtract, and Public Key Switching.

In the polynomial F2id(X), the number of blocks dividing the polynomial (the number of possible values of k in the left summation) is approximately doubled, compared to the polynomial F1_{id}(X) used in division into an even number of regions in the first example, and therefore the number of terms included in one block (the number of possible values of 1 in the right summation) is approximately halved.

The polynomial F2_{id}(X) has a denominator twice the denominator of the polynomial F1_{id}(X) and thus divides the circle group into a double number of slices (slices with a plus-side error and slices with a minus-side error). As a result, the width of one slice is halved.

Blocks originally associated with integers in order to be used as the plaintext a are each divided into two. As a lookup table by BlindRotate, a table corresponding to either one of the divided blocks is referred to.

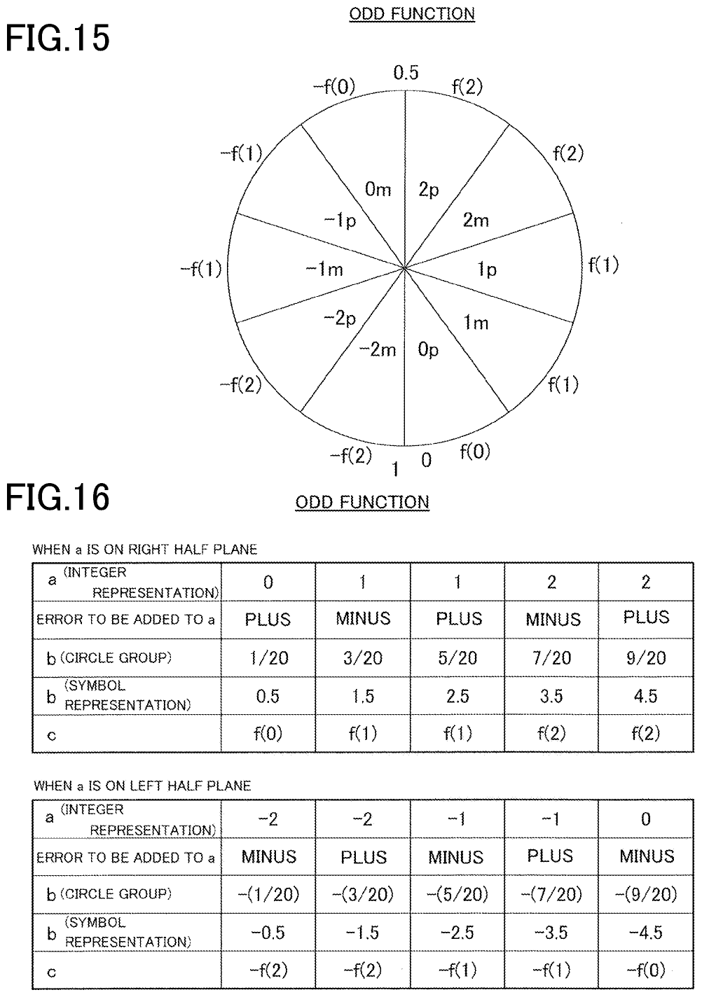

FIG. 15 is an explanatory diagram of Integer-wise type TFHE in the second example (odd function) and illustrates division of the TLWE ciphertext cb into slices.

In each slice in FIG. 15, a value of the plaintext a (an integer value) of the TLWE ciphertext ca is indicated which is assigned thereto as a result of the fifth Bootstrapping using the polynomial F2id(X) as a test vector, where p added to a numeric character indicates that a plus-side error is added to the plaintext, and m indicates that a minus-side error is added.

On the outside of the circle, values (φ(cc)) of plaintext integers of the TLWE ciphertext cc are indicated which are obtained as a result of the sixth Bootstrapping using the polynomial F2ƒ(X) as a test vector for the TLWE ciphertext cb, where φ(cc) is an integer as the output of the function ƒ or -ƒ.

FIG. 16 is an explanatory diagram of transition of a value of a ciphertext in the second example (odd function) and represents values of ciphertexts in a result of the fifth Bootstrapping and the sixth Bootstrapping. The following description is based on a case of t=2.

In a case where the plaintext integer a is 0 and a plus-side error is added, the plaintext of the TLWE ciphertext cb is 1/20 on a circle group and is represented as 0.5 by a plaintext symbol. The TLWE ciphertext cc has a value of ƒ(0) as the plaintext.

In a case where the plaintext integer a is 1 and a minus-side error is added, the plaintext of the TLWE ciphertext cb is 3/20 on the circle group and is represented as 1.5 by a plaintext symbol. The TLWE ciphertext cc has a value of ƒ(1) as the plaintext.

In a case where the plaintext integer a is 1 and a plus-side error is added, the plaintext of the TLWE ciphertext cb is 5/20 and is represented as 2.5 by a plaintext symbol. The TLWE ciphertext cc has a value of ƒ(1) as the plaintext.

In a case where the plaintext integer a is 2 and a minus-side error is added, the plaintext of the TLWE ciphertext cb is 7/20 on the circle group and is represented as 3.5 by a plaintext symbol. The TLWE ciphertext cc has a value of ƒ(2) as the plaintext.

In a case where the plaintext integer a is 2 and a plus-side error is added, the plaintext of the TLWE ciphertext cb is 9/20 on the circle group and is represented as 4.5 by a plaintext symbol. The TLWE ciphertext cc has a value of ƒ(2) as the plaintext.

In a case where the plaintext integer a is−2 and a minus-side error is added, the plaintext of the TLWE ciphertext cb is −(1/20) on the circle group and is represented as−0.5 by a plaintext symbol. The TLWE ciphertext cc has a value of−ƒ(2) as the plaintext.

In a case where the plaintext integer a is−2 and a plus-side error is added, the plaintext of the TLWE ciphertext cb is −(3/20) on the circle group and is represented as−1.5 by a plaintext symbol. The TLWE ciphertext cc has a value of−ƒ(2) as the plaintext.

In a case where the plaintext integer a is−1 and a minus-side error is added, the plaintext of the TLWE ciphertext cb is −(5/20) on the circle group and is represented as−2.5 by a plaintext symbol. The TLWE ciphertext cc has a value of−ƒ(1) as the plaintext.

In a case where the plaintext integer a is−1 and a plus-side error is added, the plaintext of the TLWE ciphertext cb is −(7/20) on the circle group and is represented as−3.5 by a plaintext symbol. The TLWE ciphertext cc has a value of−ƒ(1) as the plaintext.

In a case where the plaintext integer a is 0 and a minus-side error is added, the plaintext of the TLWE ciphertext cb is −(9/20) on the circle group and is represented as−4.5 by a plaintext symbol. The TLWE ciphertext cc has a value of−ƒ(0) as the plaintext.

The transition of a value of a ciphertext in FIG. 16 is described in detail.

The plaintext integer a is located on the right half plane of the circle group in a case where it is a positive number or 0 with a plus-side error.

In a case where the plaintext of the TLWE ciphertext ca is located on the right half plane of the circle group {T} (the plaintext is a positive number or 0 with a plus-side error), the plaintext of the TLWE ciphertext cb is moved to either one of adjacent blocks on the positive side and the negative side as a result of the fifth Bootstrapping. Specifically, the plaintext of the TLWE ciphertext cb becomes 2a−0.5 or 2a+0.5.

In a case where the plaintext of the TLWE ciphertext ca is located on the left half plane of the circle group {T} (the plaintext is a negative number, i.e., from −t to−1, or 0 with a minus-side error), the order of integers in the TLWE ciphertext ca is inverted.

For example, in a case where the plaintext integer a is 0 with a minus-side error, it is located in the section from −1/(4t+2) to 0 as a value on the circle group.

As a result of the fifth Bootstrapping using the polynomial F2id as a test vector for the TLWE ciphertext ca, the term of the highest degree block in the polynomial F2id appears as the lowest degree term with the sign reversed. Accordingly, the plaintext of the TLWE ciphertext cb obtained as a result of the fifth Bootstrapping becomes −1/2+1/(8t+4) as a value on the circle group and -2t-0.5 as a symbol.

In a case where the plaintext integer a is −t, it is −t/(2t+1) as a value on the circle group.

As a result of the fifth Bootstrapping using the polynomial F2id as a test vector for the TLWE ciphertext ca, the term of the lowest degree block (in a case of a minus-side error) or the term of the next higher degree block (in a case of a plus-side error) in the polynomial F2id appears with the sign reversed.

Therefore, the plaintext (symbol) of the TLWE ciphertext cb obtained by the fifth Bootstrapping becomes−0.5 in the case of a minus-side error and -1.5 in the case of a plus-side error.

Generalizing the above description, in the case where the plaintext integer a is a positive number or 0 with a plus-side error, the plaintext of the TLWE ciphertext cb is (2a±0.5)/(4t+2)+1/(8t+4) and is represented as 2a±0.5 as a symbol.

In the case where the plaintext integer a is a negative number or 0 with a minus-side error, the plaintext of the TLWE ciphertext cb becomes −(2t+1+2a±0.5)/2t+1/(8t+4) and is represented as −(2t+1+2a±0.5) as a symbol.

As a result of this process, in the TLWE ciphertext cb, an offset is added to the plaintext of the TLWE ciphertext ca by the term of 1/(8t+4) added to the terms in the polynomial, and the position of 0 on the circle group {T} becomes the boundary between slices, as illustrated in FIG. 16.

The encryption processing apparatus 1 extracts, from the result of the operation of the function ƒ(x) to be processed, only values in a case where x is non-negative to create the polynomial F2ƒ(X) as follows.

$${F2}_{f} ( X ) = {\sum }_{k = 0}^{2 t} ( \frac{f ( [ k / 2 ] )}{2 t + 1} + \frac{1}{4 t + 2} ) {\sum }_{l = 0}^{n / 2 t + 1 - 1} {X}^{\frac{n}{2 t + 1} k + l}$$

The encryption processing apparatus 1 then performs the sixth Bootstrapping for the TLWE ciphertext cb by using this polynomial F2ƒ(X) as a test vector, thereby obtaining the TLWE ciphertext cc. The function ƒ(x) is a function that uses an integer as an argument and obtains an integer.

The differences between the polynomial Flf(X) used in division into an even number of regions and the polynomial F2ƒ(X) are the same as the differences between the polynomial F1_{id}(X) and the polynomial F2id(X) and are that the dividing number of each term in a polynomial is approximately doubled and that the dividing number of the result also increases.

The argument of ƒ is also changed. This is because the range of k is changed.

In a case where the plaintext symbol of the TLWE ciphertext cb is non-negative, that is, 0.5, 1.5, 2.5, . . . , the plaintext of the TLWE ciphertext cb is located on the right half plane (0 to 0.5) of the circle group. In this case, the TLWE ciphertext cc obtained by performing the sixth Bootstrapping for the TLWE ciphertext cb by using the polynomial F2_{ƒ(X) as a test vector has values of ƒ(}0), ƒ(1), ƒ(1), ƒ(2), ƒ(2), . . . to correspond to the respective cases where the plaintext a (integer expression) of the TLWE ciphertext ca is 0 (with a plus-side error), 1 (with a minus-side error), 1 (with a plus-side error), 2 (with a minus-side error), 2 (with a plus-side error), . . . as the plaintext c.

In a case where the plaintext symbol of the TLWE ciphertext cb is negative, that is, −0.5, −1.5, −2.5, −3.5, . . . , they are arranged in the section from 0.5 to 1 (on the left half plane) in that order. Thus, the signs thereof have been reversed.

Therefore, the TLWE ciphertext cc has values of−ƒ(0),−ƒ(1),−ƒ(1),−ƒ(2),−ƒ(2), . . . to correspond to the respective cases where the plaintext a (integer expression) of the TLWE ciphertext ca is 0 (with a minus-side error),−1 (with a plus-side error),−1 (with a minus-side error),−2 (with a plus-side error),−2 (with a minus-side error), . . . as the plaintext c.

If ƒ(x) is an odd function,−ƒ(x)=ƒ(−x) is established. Therefore, the above result matches yp(cc)=ƒ(a).

Here, the same value of ƒ is arranged on a lookup table (a test vector polynomial) both in a case of a minus-side error and in a case of a plus-side error as illustrated in FIG. 16. As a result, the sign of the error is irrelevant. The same value as the integer a is set to at least the argument of ƒ.

[Even Function]

A case of evaluating an even function is described. This evaluation can be achieved by basically the same method as that in the case of an odd function.

The encryption processing apparatus 1 performs the seventh Bootstrapping for the TLWE ciphertext ca by using the following polynomial F2_{abs}(X) as a test vector, thereby obtaining the TLWE ciphertext cb.

$$F {2}_{abs} ( X ) = {\sum }_{k = 0}^{2 t} ( \frac{k}{4 t + 2} + \frac{1}{8 t + 4} - \frac{1}{4} ) {\sum }_{l = 0}^{n / 2 t + 1 - 1} {X}^{\frac{n}{2 t + 1} k + l}$$

The polynomial F2_{abs}(X) is different from the above polynomial F2_{id}(X) in that 1/4 is subtracted from each term in the polynomial.

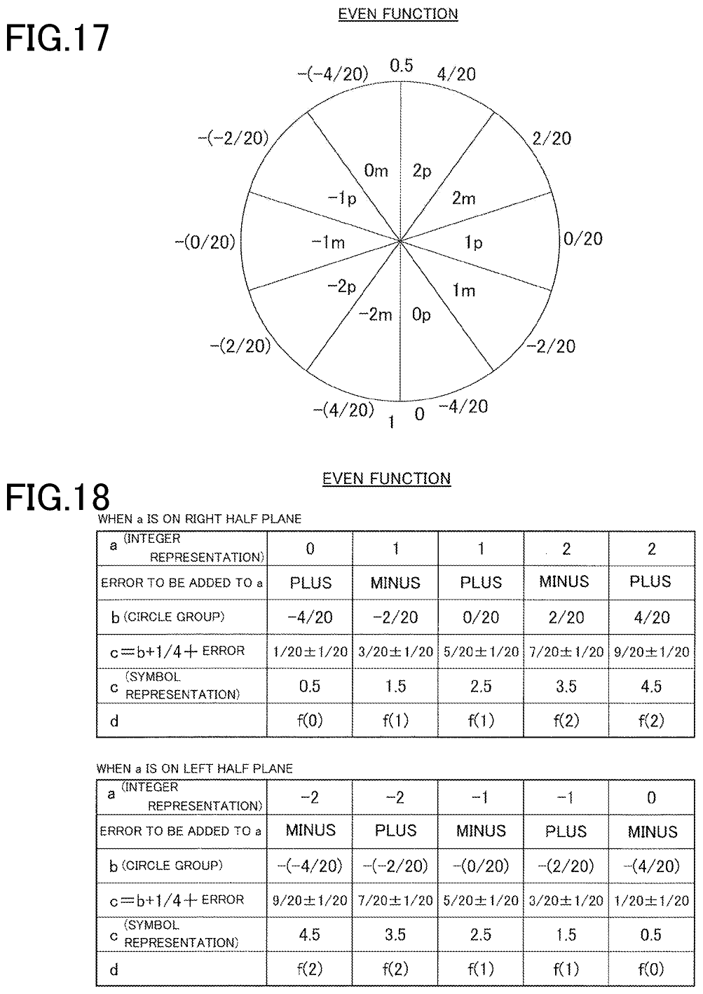

FIG. 17 is an explanatory diagram of Integer-wise type TFHE in the second example (even function) and illustrates transition of a value of a ciphertext through the seventh Bootstrapping and the eighth Bootstrapping.

In each slice in FIG. 17, a value of the plaintext a (an integer value) of the TLWE ciphertext ca is indicated which is assigned to the slices as a result of the seventh Bootstrapping using the polynomial F2_{abs}(X) as a test vector, where p added to a numeric character indicates that a plus-side error is added, and m added to a numerical character indicates that a minus-side error is added.

The order of the plaintexts of the TLWE ciphertext ca before conversion is indicated inside the circle, and the centers of the plaintexts of the TLWE ciphertext cb after being processed by the seventh Bootstrapping are indicated outside the circle. An error of ±1/20 is added to the center of each plaintext.

On the right half plane of the circle group, the plaintexts are arranged in the same way as coefficients in the test vector polynomial. On the left half plane, the plaintexts are arranged with the sign reversed in such a manner that the order of the plaintexts is inverted. 0 is located on both the left side and the right side and is converted to the same value, i.e.,−4/20 on both the sides.

FIG. 18 is an explanatory diagram of transition of a value of a ciphertext in the second example (even function). The following description is based on a case of t=2.

In the description related to FIG. 18, the TLWE ciphertext cc is obtained by adding 1/4 to the TLWE ciphertext cb in a homomorphic manner.

In a case where the plaintext integer a is 0 and a plus-side error is added, the plaintext of the TLWE ciphertext cb is−4/20 on a circle group. The TLWE ciphertext cc is 1/20±1/20 which includes the error and is represented by 0.5 as a symbol. The TLWE ciphertext cd has a value of ƒ(0) as the plaintext.

In a case where the plaintext integer a is 1 and a minus-side error is added, the plaintext of the TLWE ciphertext cb is−2/20 on the circle group. The TLWE ciphertext cc is 3/20±1/20 which includes the error and is represented by 1.5 as a symbol. The TLWE ciphertext cd has a value of ƒ(1) as the plaintext.

In a case where the plaintext integer a is 1 and a plus-side error is added, the plaintext of the TLWE ciphertext cb is 0/20. The TLWE ciphertext cc is 5/20±1/20 which includes the error and is represented by 2.5 as a symbol. The TLWE ciphertext cd has a value of ƒ(1) as the plaintext.

In a case where the plaintext integer a is 2 and a minus-side error is added, the plaintext of the TLWE ciphertext cb is 2/20. The TLWE ciphertext cc is 7/20±1/20 which includes the error and is represented by 3.5 as a symbol. The TLWE ciphertext cd has a value of ƒ(2) as the plaintext.

In a case where the plaintext integer a is 2 and a plus-side error is added, the plaintext of the TLWE ciphertext cb is 4/20. The TLWE ciphertext cc is 9/20±1/20 which includes the error and is represented by 4.5 as a symbol. The TLWE ciphertext cd has a value of ƒ(2) as the plaintext.

In a case where the plaintext integer a is−2 and a minus-side error is added, the plaintext of the TLWE ciphertext cb is −(−4/20) on the circle group. The TLWE ciphertext cc is 9/20±1/20 which includes the error and is represented by 4.5 as a symbol. The TLWE ciphertext cd has a value of ƒ(2) as the plaintext.

In a case where the plaintext integer a is−2 and a plus-side error is added, the plaintext of the TLWE ciphertext cb is −(−2/20) on the circle group. The TLWE ciphertext cc is 7/20±1/20 which includes the error and is represented by 3.5 as a symbol. The TLWE ciphertext cd has a value of ƒ(2) as the plaintext.

In a case where the plaintext integer a is−1 and a minus-side error is added, the plaintext of the TLWE ciphertext cb is −(0/20) on the circle group. The TLWE ciphertext cc is 5/20±1/20 which includes the error and is represented by 2.5 as a symbol. The TLWE ciphertext cd has a value of ƒ(1) as the plaintext.

In a case where the plaintext integer a is−1 and a plus-side error is added, the plaintext of the TLWE ciphertext cb is −(2/20) on the circle group. The TLWE ciphertext cc is 3/20±1/20 which includes the error and is represented by 1.5 as a symbol. The TLWE ciphertext cd has a value of ƒ(1) as the plaintext.

In a case where the plaintext integer a is 0 and a minus-side error is added, the plaintext of the TLWE ciphertext cb is −(4/20) on the circle group. The TLWE ciphertext cc is 1/20±1/20 which includes the error and is represented by 0.5 as a symbol. The TLWE ciphertext cd has a value of ƒ(0) as the plaintext.

The transition of a value of a ciphertext in FIG. 18 is described in detail.

The plaintext integer a is located on the right half plane of the circle group in a case where it is a positive number or 0 with a plus-side error.

When the denominator of the plaintext of the TLWE ciphertext cb is found as 20 (=8t+4), the numerator the plaintext of the TLWE ciphertext cb in a case of a=0 (with a plus-side error) is−4 from (2k)+(1)−(2t+1)=2k−2t.

The numerator of the plaintext of the TLWE ciphertext cb in a case of a=1 (with a minus-side error) is −2.

The numerator of the plaintext of the TLWE ciphertext cb in a case of a=1 (with a plus-side error) is 0.

The numerator of the plaintext of the TLWE ciphertext cb in a case of a=2 (with a minus-side error) is +2.

The numerator of the plaintext of the TLWE ciphertext cb in a case of a=2 (with a plus-side error) is +4.

The plaintext integer a is located on the left half plane of the circle group in a case where it is a negative number or 0 with a minus-side error. In this case, the plaintexts of the TLWE ciphertext cb are obtained with the sign reversed from those in a case where the plaintext integer a is positive to be arranged in a direction from 0.5 to 1. Therefore, in a case of a=−2 (with a minus-side error), the numerator of the plaintext of the TLWE ciphertext cb is 4 as a result of sign reversal from the result in a case of a=0 (with a plus-side error).

In a case of a=−2 (with a plus-side error), the numerator of the plaintext of the TLWE ciphertext cb is 2 as a result of sign reversal of the result in a case of a=1 (with a minus-side error).

In a case of a=0 (with a minus-side error), the numerator of the plaintext of the TLWE ciphertext cb is−4 as a result of sign reversal of the result in a case of a=2 (with a plus-side error).

The encryption processing apparatus 1 adds a trivial ciphertext (0, 1/4) to the ciphertext cb to obtain the TLWE ciphertext cc.

Since 1/4 is written as 5/20, 5 is added to the numerator of the plaintext b of the TLWE ciphertext cb, so that all the plaintexts b can be placed on the right half plane. Although an error in a range of ±1/(4t+2) is added, the plaintext falls within the range from 0 to 0.5 (the right half plane) even if the added error is considered.

Since the denominator is 20, and the numerator increases in increments of 2, the TLWE ciphertext cc can be regarded as a non-negative ciphertext in a case of dividing the entire circle group into 10 regions (dividing the entire circle group into the number of regions, the number being obtained by doubling 2t+1=5) and using it.

Also, as for the order, the numerator of the plaintext of the ciphertext cc becomes larger as the distance from a=0 increases on the positive side and on the negative side, and it can be said that an absolute value function has been calculated.

Since the plaintext of the TLWE ciphertext cc already uses the right half plane of the circle group only, a desired function can be evaluated by the method in Micciancio and Polyakov, 2020. However, the plaintext c of the TLWE ciphertext cc is arranged in one of two slices on the circle group, depending on whether the error added to the plaintext a in the TLWE ciphertext ca is a plus-side error or a minus-side error.

Therefore, adjustment is performed in such a manner that the same result is obtained for two slices that are originally the same slice corresponding to the same integer, as in the case of an odd function.

Specifically, assuming that the function ƒ(x) is a function that can obtain an integer by using an integer as an argument, the eighth Bootstrapping is performed for the TLWE ciphertext cc by using the polynomial F2_{ƒ(X)}

$$F {2}_{f} ( X ) = {\sum }_{k = 0}^{2 t} ( \frac{f ( [ k / 2 ] )}{2 t + 1} + \frac{1}{4 t + 2} ) {\sum }_{l = 0}^{n / 2 t + 1 - 1} {X}^{\frac{n}{2 t + 1} k + l}$$

that is the same as that in a case of an odd function as a test vector, thereby obtaining the TLWE ciphertext cd.

Accordingly, φ(cd)=ƒ(|a|) can be calculated, where is an absolute value symbol.

If ƒ(x) is an even function, ƒ(x)=ƒ(−x) is established in a case where x is a non-negative integer. Thus, the above result matches φ(cd)=ƒ(a).

The same value of ƒ is arranged on a lookup table (a test vector polynomial) both in a case of a minus-side error and in a case of a plus-side error, as illustrated in FIG. 18. As a result, the sign of the error is irrelevant.

As described above, the encryption processing apparatus 1 can use an entire circle group without waste when using TFHE as the Integer-wise type for division into an odd number of regions, and also can calculate a desired univariate function only for an even function and an odd function.

In the present embodiment, blocks of terms in a test vector polynomial in the first stage are each divided more finely than in actual division of a circle group, and a plurality of blocks in the blocks are converted to the same value to make that value coincident with the original value in the second stage. Such processes enable evaluation of an even function and an odd function even in a case where the entire circle group is divided into an odd number of regions.

### Third Example

A process for obtaining a value of a polynomial (a value of a polynomial function) is described below as a third example.

In the third example, when obtaining a value of a polynomial, the encryption processing apparatus 1 divides terms of a desired polynomial into terms of even number degrees and terms of odd number degrees, obtains x², x³, x⁴, . . . for each of them, and finally linearly combines them together (multiplies each output by a constant and sums up). Since the 0th degree term is a constant, and the first degree term is an original value, it suffices to calculate terms of the second degree or more (x to the power of 2 or more). Accordingly, even if Bootstrapping performed twice in a common step is included, calculation can be performed by Bootstrapping the same number of times as the degree of the polynomial at most.

Further, instead of calculating each term one by one, it is preferable to divide a polynomial xⁿ +xⁿ⁻¹+ . . . into terms of even number degrees and terms of odd number degrees and to convert them to an even function and an odd function, respectively, by the following method of decomposition into an even function and an odd function.

“Putting up the swiss army knife of homomorphic calculations by means of TFHE functional bootstrapping, Pierre-Emmanuel Clet, Martin Zuber, Aymen Boudguiga, Renaud Sirdey, and Cedric Gouy-Pailler” in the aforementioned paper discloses decomposing any univariate function to be calculated into an even function and an odd function, obtaining a ciphertext of an operation result for each of them, and adding the ciphertexts together finally, thereby obtaining a ciphertext of a result of calculation of the univariate function.

As for decomposition of a function into an even function and an odd function, the following formulas are defined by using any univariate function ƒ(x).

$${f}_{e} ( x ) = \frac{f ( x ) + f ( - x )}{2} \\ {f}_{o} ( x ) = \frac{f ( x ) - f ( - x )}{2}$$

When both are added together simply, ƒ(x)=fe(x)+fo(x). Therefore, these two functions fe(x) and fo(x) are results of decomposition of the univariate function ƒ(x) into two.

Further, from the form of the formula, it is found that, even if the sign of x in fe(x) is reversed, only change caused by the sign reversal is swap of the left side and the right side of the sign+in the formula. Therefore, fe(x)=fe(−x) is established, that is, fe(x) is an even function.

Similarly, ƒ in the left side and ƒ in the right side of the sign -in the formula are exchanged, so that the same form as−fo(x) is obtained. That is, fo(−x)=−fo(x) is established, and fo(x) is an odd function.

From the above discussion, obtaining fe(x) and fo(x) in the above-described manner is equivalent to decomposing any univariate function ƒ(x) into an even function and an odd function.

The above discussion is established for any univariate function without specifying whether what is assigned to x is a real number, an integer, or a complex number and specifying whether ƒ(x) is a polynomial, for example.

For calculation of an even function and calculation of an odd function, both the method in the first example that divides a circle group into an even number of regions and the method in the second example that divides a circle group into an odd number of regions can be used.

If there is a desired function ƒ(x) to be calculated, a value of the function ƒ(x) can be calculated by decomposing this function as represented by ƒ(x)=fe(x)+fo(x), calculating each of a value of an odd function fo(x) and a value of an even function fe(x), and adding the calculated values together.

In a case of using the method in the first example, the odd function fo(x) and the even function fe(x) can be calculated by Method 2 and Method 3 described above, for example.

In this case, the encryption processing apparatus 1 performs Bootstrapping twice for each of calculation of the odd function fo(x) and calculation of the even function fe(x), that is, four times in total, as described in relation to Method 2 and Method 3. Specifically, the encryption processing apparatus 1 performs the first Bootstrapping and the second Bootstrapping for the odd function fo(x) and performs the third Bootstrapping and the fourth Bootstrapping for the even function fe(x).

Then, the encryption processing apparatus 1 can calculate the desired function ƒ(x) by adding a ciphertext having as its plaintext a value of fe(x) and a ciphertext having as its plaintext a value of fo(x) together. Depending on the form of the function, both fe(x) and fo(x) may have a fraction of 0.5. However, these fractions are eliminated when addition is finally performed, and therefore cause no problem.

Further, if there is a desired function g(x) to be calculated, ƒ(x) may be set as ƒ(x)=g(x−0.5) and be decomposed into an even function fe(x+0.5) and an odd function fo(x+0.5). In this case, the odd function fo(x+0.5) and the even function fe(x+0.5) can be calculated by Method 1 and Method 4 described above.

In this case, the encryption processing apparatus 1 performs Bootstrapping twice for each of calculation of the odd function fo(x+0.5) and calculation of the even function fe(x+0.5), that is, four times in total, as described in relation to Method 1 and Method 4. Specifically, the encryption processing apparatus 1 performs the first Bootstrapping and the second Bootstrapping for the odd function fo(x+0.5) and performs the third Bootstrapping and the fourth Bootstrapping for the even function fe(x+0.5).

Since g(x)=ƒ(x+0.5) is obtained from ƒ(x)=g(x-0.5), a value of fo(k+0.5) and a value of fe(k+0.5) configuring test vector polynomials used in Method 1 and Method 4 can be calculated by using g(k) and g(−k).

The encryption processing apparatus 1 obtains a ciphertext ce by adding a ciphertext having a value of fo(a+0.5) as its plaintext and a ciphertext having a value of a cyphertext of fe(a+0.5) as its plaintext together in a homomorphic manner, where the value of fo(a+0.5) and the value of fe(a+0.5) are respectively obtained by Method 1 and Method 4.

The plaintext φp(ce) of the ciphertext ce becomes fe(a+0.5)+fo(a+0.5)=ƒ(a+0.5)=g(k).

The desired function g(x) can thus be calculated.

As described above, Method 1 and Method 4 performed by the encryption processing apparatus 1 for calculating an odd function and an even function, respectively, use the following polynomials as step polynomials.

$$F {1}_{id} ( X ) = {\sum }_{k = 0}^{t - 1} ( \frac{k}{2 t} + \frac{1}{4 t} ) {\sum }_{l = 0}^{n / t - 1} {X}^{\frac{n}{t} k + l} \\ F {1}_{abs}^{′} ( X ) = {\sum }_{k = 0}^{t - 1} ( \frac{k}{2 t} + \frac{1}{4 t} - \frac{1}{4} ) {\sum }_{l = 0}^{n / t - 1} {X}^{\frac{n}{t} k + l}$$

Further, Method 2 and Method 3 performed by the encryption processing apparatus 1 for calculating an odd function and an even function, respectively, use the following polynomials as step polynomials.

$$F {1}_{id}^{′} ( X ) = {\sum }_{k = 0}^{t - 1} ( \frac{k}{2 ( t + 1 )} + \frac{1}{4 ( t + 1 )} ) {\sum }_{l = 0}^{n / t - 1} {X}^{\frac{n}{t} k + l} \\ F {1}_{abs} ( X ) = {\sum }_{k = 0}^{t - 1} ( \frac{k}{2 ( t + 1 )} + \frac{1}{4 ( t + 1 )} - \frac{1}{4} ) {\sum }_{l = 0}^{n / t - 1} {X}^{\frac{n}{t} k + l}$$

The denominator 2t appearing in the polynomials used in Method 1 and Method 4 is smaller than the denominator 2(t+1) appearing in the polynomials used in Method 2 and Method 3. Therefore, when Method 1 and Method 4 are used, the dividing number in a ciphertext appearing in the middle is smaller than when Method 2 and Method 3 are used.

Since the range assigned to one slice can be widened in inverse proportion to decrease in the dividing number, resistance to noise can be enhanced.

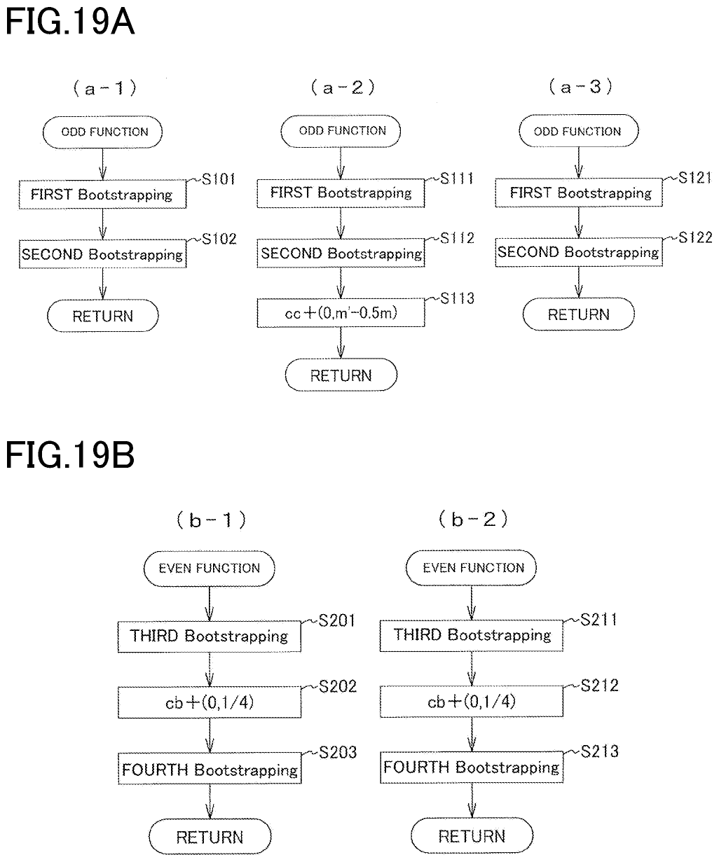

FIGS. 19A and 19B are flowcharts for explaining processing according to the first example (division into an even number of regions).

FIG. 19A represents processing of performing an operation of an odd function.

In (a-1), the encryption processing apparatus 1 (the first calculation unit 15) performs the first Bootstrapping for the TLWE ciphertext ca that has been received as input by using the polynomial F1_{id}(X) as a test vector, thereby obtaining the TLWE ciphertext cb at Step S101.

At Step S102, the encryption processing apparatus 1 (the second calculation unit 16) performs the second Bootstrapping for the TLWE ciphertext cb by using the polynomial Flf(X) as a test vector, thereby obtaining the ciphertext cc.

In (a-2), the encryption processing apparatus 1 (the first calculation unit 15) performs the first Bootstrapping for the TLWE ciphertext ca as an object, which has been received as input, by using the polynomial F1_{id}(X) as a test vector to obtain the TLWE ciphertext cb, at Step S111.

At Step S112, the encryption processing apparatus 1 (the second calculation unit 16) performs the second Bootstrapping for the TLWE ciphertext cb by using the polynomial Flf(X) as a test vector to obtain the ciphertext cc.

At Step S113, the encryption processing apparatus 1 (the first operation unit 12) performs a homomorphic operation of cc+(0, m′−0.5m) for the TLWE ciphertext cc to obtain the new TLWE ciphertext cd.

In (a-3), the encryption processing apparatus 1 (the first calculation unit 15) performs the first Bootstrapping for the TLWE ciphertext ca as an object, which has been received as input, by using the polynomial F1′_{id}(X) as a test vector to obtain the TLWE ciphertext cb, at Step S121.

At Step S122, the encryption processing apparatus 1 (the second calculation unit 16) performs the second Bootstrapping for the TLWE ciphertext cb by using the polynomial F1′_{ƒ(X) as a test vector, thereby obtaining the TLWE ciphertext cc.}

FIG. 19B represents processing of performing an operation of an odd function.

In (b-1), the encryption processing apparatus 1 (the third calculation unit 17) performs the third Bootstrapping for the TLWE ciphertext ca as an object, which has been received as input, by using the polynomial F1_{abs}(X) as a test vector to obtain the TLWE ciphertext cb at Step S201.

At Step S202, the encryption processing apparatus 1 (the second operation unit 13) performs a homomorphic operation of cb+(0, 1/4) for the ciphertext cb, thereby obtaining the TLWE ciphertext cc.

At Step S203, the encryption processing apparatus 1 (the fourth calculation unit 18) performs the fourth Bootstrapping for the TLWE ciphertext cc by using the polynomial F1′_{ƒ(X) as a test vector, thereby obtaining the TLWE ciphertext cd.}

In (b-2), the encryption processing apparatus 1 (the third calculation unit 17) performs the third Bootstrapping for the TLWE ciphertext ca as an object, which has been received as input, by using the polynomial F1′_{abs}(X) as a test vector, thereby obtaining the TLWE ciphertext cb at Step S211.

At Step S212, the encryption processing apparatus 1 (the second operation unit 13) performs a homomorphic operation of cb+(0, 1/4) for the ciphertext cb, thereby obtaining the TLWE ciphertext cc.

At Step S213, the encryption processing apparatus 1 (the fourth calculation unit 18) performs the fourth Bootstrapping for the TLWE ciphertext cc by using the polynomial Flf(X) as a test vector to obtain the TLWE ciphertext cd.

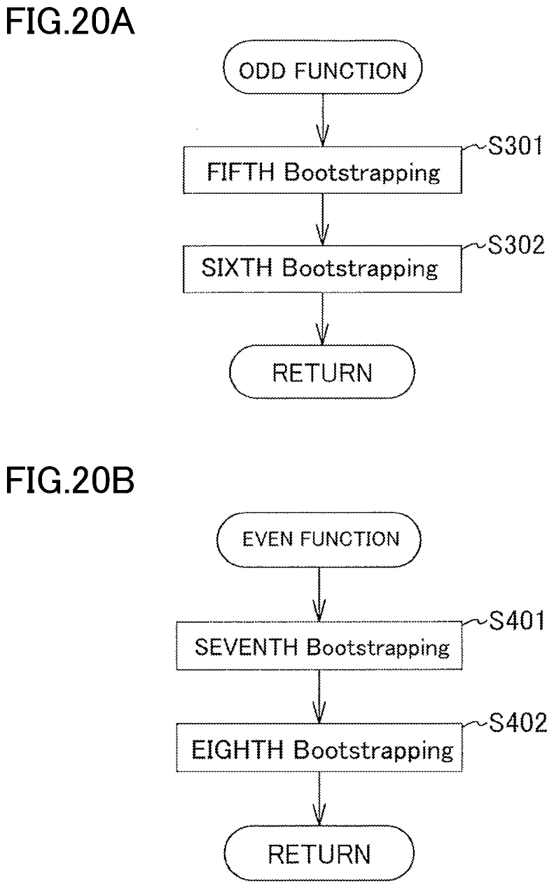

FIGS. 20A and 20B are flowcharts for explaining processing according to the second example (division into an odd number of regions).

FIG. 20A represents processing of performing an operation of an odd function.

At Step S301, the encryption processing apparatus 1 (the fifth calculation unit 41) performs the fifth Bootstrapping for the TLWE ciphertext ca as an object, which has been received as input, by using the polynomial F2id(X) as a test vector to obtain the TLWE ciphertext cb.

At Step S302, the encryption processing apparatus 1 (the sixth calculation unit 42) performs the sixth Bootstrapping for the ciphertext cb by using the polynomial F2ƒ(X) as a test vector, thereby obtaining the TLWE ciphertext cc.

FIG. 20B represents processing of performing an operation of an even function.

At Step S401, the encryption processing apparatus 1 (the seventh calculation unit 43) performs the seventh Bootstrapping for the TLWE ciphertext ca as an object, which has been received as input, by using the polynomial F2_{abs}(X) as a test vector to obtain the TLWE ciphertext cb. At Step S402, the encryption processing apparatus 1 (the eighth calculation unit 44) performs the eighth Bootstrapping for the ciphertext cb by using the polynomial F2′_{ƒ(X) as a test vector to obtain the TLWE ciphertext cc.}

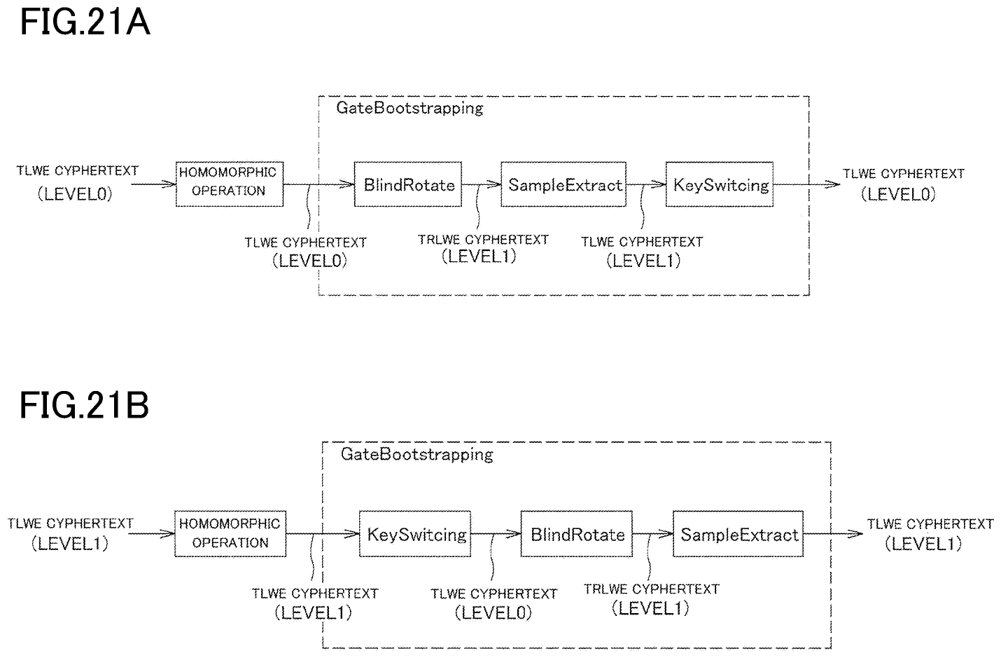

FIGS. 21A and 21B are diagrams illustrating ciphertexts input to and output from Gate Bootstrapping in the present embodiment.

In the above descriptions, Gate Bootstrapping, in particular, the first Bootstrapping has been described as being performed in the order of BlindRotate, SampleExtract, and Public Key Switching, as illustrated in FIG. 21A.

The order is not limited thereto. In Gate Bootstrapping, Public Key Switching can be performed first, and thereafter BlindRotate and SampleExtract can be performed, as illustrated in FIG. 21B.

As for TLWE ciphertexts, there is a concept of levels depending on security strengths.

In Gate Bootstrapping in FIG. 21A, TLWE ciphertexts as input and output are at LEVEL0. A TLWE ciphertext obtained by performing BlindRotate for a LEVEL0 TLWE ciphertext and performing SampleExtract for a TRLWE ciphertext as the output of BlindRotate is at LEVEL1. However, as a result of Public Key Switching, a LEVEL0 TLWE ciphertext is output.

Meanwhile, in the method illustrated in FIG. 21B, TLWE ciphertexts as input and output of the Gate Bootstrapping are set to LEVEL1, and Public Key Switching is performed first to lower the level to LEVEL0. In this state, BlindRotate is performed. When SampleExtract is then performed for the TRLWE ciphertext as the output of BlindRotate, a LEVEL1 TLWE ciphertext is output.

The LEVEL0 ciphertext is formed by an N-th order vector [a] of elements on the circle group {T} encrypted with an N-th order private key [s]. Meanwhile, the LEVEL1 ciphertext obtained as a result of SampleExtract is formed by an n-th order vector [a′] of elements on the circle group {T} encrypted with an n-th order private key [s′].

In the LEVEL0 ciphertext, the number of coefficients (the order of the vector) contributing to difficulty of the LWE problem is smaller than that in the LEVEL1 ciphertext, and thus the amount of calculation of homomorphic addition is smaller as compared with the LEVEL1 ciphertext.

On the other hand, the LEVEL0 ciphertext has a problem that the security strength tends to decrease when an allowable error added to a plaintext is made small. This is because in LWE encryption, the security is ensured by the error added to the plaintext.

In TLWE encryption, calculation (decipher) is more difficult as the error added to the plaintext is larger and the number of coefficients (the order of the vector) is larger.

In other words, regarding TLWE encryption, the smaller the error added to the plaintext is and the smaller the number of coefficients (the order of the vector) is, the easier calculation (decipher) is.

In particular, in TFHE applied to the Integer-wise type, it is necessary to divide the range from 0 to 1 of the circle group {T} more finely as the value of the plaintext (integer) stored in a TLWE ciphertext becomes larger. Thus, an error needs to be made smaller also because of a problem of an error in decryption which will be described later. In this case, the security strength tends to decrease, as described above. Therefore, in order to make the error smaller, it is necessary to ensure security by increasing the number of coefficients (the order of the vector) in the ciphertext.

In order to ensure the security of the ciphertext that is easy to calculate (decipher) by reducing the error added to the plaintext, it is desirable to move Public Key Switching to the beginning of Gate Bootstrapping and to use the LEVEL1 ciphertexts, having a large number of coefficients (the order of the vector) and is easy to make an error range smaller, as input and output of Gate Bootstrapping. Then, after conversion to LEVEL0 is performed at the beginning of Gate Bootstrapping, the level is not returned to LEVEL0 at the end. By not returning the level to the LEVEL0, it is possible to safely perform calculation of the TLWE ciphertext also in the next stage.

The time required for BlindRotate is proportional to the number of coefficients (the order of the vector) of the input TLWE ciphertext, because the number of times of CMux is the same as the order. Therefore, when the LEVEL1 ciphertext is input, the time required for BlindRotate becomes longer in proportion to the number of coefficients (the order of the vector) than when the LEVEL0 ciphertext is input.

Even if a LEVEL1 ciphertext is input to Gate Bootstrapping in order to ensure the security of the ciphertext, it is possible to avoid increase in the required time by performing BlindRotate using the LEVEL0 TLWE ciphertext obtained by conversion by Public Key Switching as input.

Further, making an error to be added to a plaintext smaller has a problem of an error in decryption in addition to the above-described problem of security strength.

As described above, in TFHE applied to Integer-wise type, the range from 0 to 1 associated with the circle group {T} is divided into 2t. When the value of t is made larger and the circle group is more finely divided, the integer value that can be recorded in a TLWE ciphertext can be further increased. The maximum value that can be stored is determined by the number t of divisions of the circle group. However, since it is necessary to make the error range smaller in order to store a large value, there are a problem that the security strength decreases and a problem that the decryption error rate increases.

In LWE homomorphic encryption including TFHE, errors added to plaintexts are distributed in the normal distribution, and it is not possible to strictly set an “error range”.

In principle, it is only possible to concentrate more errors in a specified range, although there is no change in the concentration around 0.

When the error is out of the set range, the corresponding plaintext is interpreted as another plaintext, and thus an unexpected calculation result may be obtained.

The calculation itself does not become impossible, but only a different result is obtained. How much probability that a different calculation result is obtained is acceptable depends on the application to which homomorphic encryption is applied.

It is necessary to set a system parameter to make the overlap of error ranges fall within certain values in order to best balance three objectives of suppressing the probability of occurrence of an error in calculation, speeding up calculation by reducing the number of times of BlindRotate, and maintaining high security.

The error may be set so as to satisfy a particularly important condition in accordance with a system or a device to which the present embodiment is applied.

### Application Example

The encryption processing apparatus 1 performs calculation of an even function and calculation of an odd function in division into an even number of regions (the first example) by using the functions of the first operation unit 12, the second operation unit 13, the first Bootstrapping unit 15, the second Bootstrapping unit 16, the third Bootstrapping unit 17, and the fourth Bootstrapping unit 18.

The encryption processing apparatus 1 performs calculation of an even function and calculation of an odd function in division into an odd number of regions (the second example) by using the functions of the fifth Bootstrapping unit 41, the sixth Bootstrapping unit 42, the seventh Bootstrapping unit 43, and the eighth Bootstrapping unit 44.

The processes performed by the encryption processing apparatus 1 can be applied in the following manner.

Specific application examples include fuzzy authentication such as biometric authentication (since this authentication uses data that does not change over a lifetime, it is an absolute condition to conceal the data, and determination is made whether to match the data by using a threshold value), fuzzy search that searches a database for ambiguous and close data, and query aggregation from an encrypted database.

Fuzzy authentication is biometric authentication using, for example, biometric authentication data, and it is an absolute condition that biometric authentication data that does not change over a lifetime is encrypted and concealed.

In fuzzy authentication, authentication is performed based on a correspondence between biometric authentication data presented as an authentication request and biometric authentication data registered in a database. It is determined whether both the data match each other with a threshold, instead of determining whether both the data completely match each other, because, even if biological information is measured accurately, it is not always possible to obtain exactly the same value.

Fuzzy search is an ambiguous search method in which data close to a query is presented as a search result from a database even if the query and a record do not completely match.

In fuzzy authentication and fuzzy search, it is necessary to perform various operations for data encrypted by homomorphic encryption when a query to the encrypted database is executed. Those operations include an operation using a function that is a univariate function and an even function or an odd function. For example, in a case of using the Euclidean distance for calculating the degree of coincidence with a fingerprint registered in fuzzy authentication, x², which is an even function, is calculated. Further, in a case of converting the scale for normalization of a vector, for example, multiplication of the scale, i.e., the first-degree polynomial, which is an odd function, is calculated. Furthermore, any univariate function that can be calculated by calculating an even function or an odd function is also necessary when fuzzy authentication, fuzzy search, and a query for an encrypted database are executed.

The fact that a desired variable function can be calculated while being encrypted is useful also in calculation of cosine similarity that is used for, for example, evaluating the similarity between sentences and is obtained by dividing the inner product of two vectors by their respective norms.

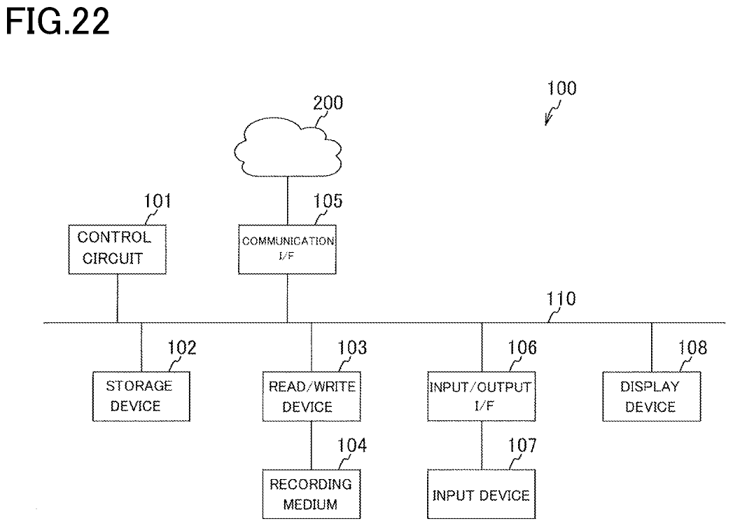

FIG. 22 is a block diagram illustrating an example of a computer apparatus.

A configuration of a computer apparatus 100 is described with reference to FIG. 22.

The computer apparatus 100 is, for example, an encryption processing apparatus that processes various types of information. The computer apparatus 100 includes a control circuit 101, a storage device 102, a read/write device 103, a recording medium 104, a communication interface 105, an input/output interface 106, an input device 107, and a display device 108.

The communication interface 105 is connected to a network 200. The respective constituent elements are mutually connected to one another via a bus 110.

The encryption processing apparatus 1 can be configured by selecting a part of or all elements from the constituent elements incorporated in the computer apparatus 100 as appropriate.

The control circuit 101 controls the entire computer apparatus 100. For example, the control circuit 101 is a processor such as a Central Processing Unit (CPU), a Field Programmable Gate Array (FPGA), an Application Specific Integrated Circuit (ASIC), and a Programmable Logic Device (PLD). The control circuit 101 functions as the controller 10 in FIG. 1, for example.

The storage device 102 stores various types of data therein. For example, the storage device 102 is a memory such as a Read Only Memory (ROM) and a Random Access Memory (RAM), or a non-transitory computer-readable recording medium such as a Hard Disk (HD) and a Solid State Drive (SSD). The storage device 102 may store therein an information processing (encryption processing) program that causes the control circuit 101 to function as the controller 10 in FIG. 1. The storage device 102 functions as the storage unit 20 in FIG. 1, for example.

The encryption processing apparatus 1 loads a program stored in the storage device 102 into a RAM when performing information processing (encryption processing).

When an operation of an odd function is performed in a case of division into an even number of regions, the encryption processing apparatus 1 executes the program loaded to the RAM by the control circuit 101, thereby executing processing that includes at least one of a receiving process, the first operation process, the first Bootstrapping process, the second Bootstrapping process, and an output process.

When an operation of an even function is performed in the case of division into an even number of regions, the encryption processing apparatus 1 executes the program loaded to the RAM by the control circuit 101, thereby executing processing that includes at least one of the receiving process, the second operation process, the third Bootstrapping process, the fourth Bootstrapping process, and the output process.

When an operation of an odd function is performed in a case of division into an odd number of regions, the encryption processing apparatus 1 executes the program loaded to the RAM by the control circuit 101, thereby executing processing that includes at least one of the receiving process, the fifth Bootstrapping process, the sixth Bootstrapping process, and the output process.

When an operation of an even function is performed in the case of division into an odd number of regions, the encryption processing apparatus 1 executes the program loaded to the RAM by the control circuit 101, thereby executing processing that includes at least one of the receiving process, the seventh Bootstrapping process, the eighth Bootstrapping process, and the output process.

The program may be stored in a storage device included in a server on the network 200, as long as the control circuit 101 can access that program via the communication interface 105.

The read/write device 103 is controlled by the control circuit 101, and reads data in the removable recording medium 104 and writes data to the removable recording medium 104.

The recording medium 104 stores various types of data therein. The recording medium 104 stores information processing (encryption processing) program therein, for example. For example, the recording medium 104 is a nonvolatile memory (a non-transitory computer-readable recording medium) such as a Secure Digital (SD) memory card, a Floppy Disk (FD), a Compact Disc (CD), a Digital Versatile Disk (DVD), a Blu-ray (registered trademark) Disk (BD), and a flash memory.

The communication interface 105 connects the computer apparatus 100 and another device to each other via the network 200 in a communicable manner. The communication interface 105 functions as the communication unit 25 in FIG. 1, for example.

The input/output interface 106 is, for example, an interface that can be connected to various types of input devices in a removable manner. Examples of the input device 107 connected to the input/output interface 106 include a keyboard and a mouse. The input/output interface 106 connects each of the various types of input devices connected thereto and the computer apparatus 100 to each other in a communicable manner. The input/output interface 106 outputs a signal input from each of the various types of input devices connected thereto to the control circuit 101 via the bus 110. The input/output interface 106 also outputs a signal output from the control circuit 101 to an input/output device via the bus 110. The input/output interface 106 functions as the input unit 26 in FIG. 1, for example.

The display device 108 displays various types of information. The display device 108 is, for example, a CRT (Cathode Ray Tube), an LCD (Liquid Crystal Display), a PDP (Plasma Display Panel), and an OELD (Organic Electroluminescence Display). The network 200 is, for example, a LAN, wireless communication, a P2P network, or the Internet and communicably connects the computer apparatus 100 to other devices.

The present embodiment is not limited to the embodiment described above and various configurations or embodiments can be applied within a scope not departing from the gist of the present embodiment.

All examples and condition statements aided herein are intended for educational purposes to help the reader understand the concepts contributed by the inventor to further the invention and the art, and are to be construed as not limited to such specifically aided examples and conditions, and the construction of such examples is not relevant to depicting the superiority of the invention. While embodiments of the invention have been described in detail, it is to be understood that various changes, substitutions, and modifications may be made herein without departing from the spirit and scope of the invention.

What is claimed is:

1. An encryption processing apparatus that processes a ciphertext, the ciphertext being a fully homomorphic ciphertext that has a value with an error as a plaintext associated with an integer and that enables an operation between integers without decryption, the error having a predetermined variance in a divided region obtained by dividing a range into a predetermined number of regions, the apparatus comprising a processor which executes a process including:
applying a first polynomial to a first ciphertext to obtain a second ciphertext, the first polynomial being configured to be able to select an operation result in units smaller than the divided region used as one plaintext symbol corresponding to the first ciphertext in the range; and
converting two or more of plaintext symbols corresponding to the second ciphertext to the same one plaintext symbol by applying a second polynomial to the second ciphertext, to obtain a third ciphertext corresponding to an operation result of a predetermined operation.

2. The encryption processing apparatus according to claim 1, wherein
the first polynomial is a step polynomial,
the second polynomial is constructed by using either one of a third polynomial and a fourth polynomial different from the third polynomial, and
the processor applies the third polynomial to the second ciphertext when a dividing number of the range in the first ciphertext is an even number and applies the fourth polynomial to the second ciphertext when the dividing number is an odd number, to obtain the third ciphertext irrespective of whether the dividing number is even or odd.

3. The encryption processing apparatus according to claim 1, wherein
assuming a possible maximum integer to which the plaintext of the ciphertext
the first polynomial is a polynomial for performing a manipulation of obtaining a ciphertext corresponding to a value obtained by looking up a plaintext of the first ciphertext in a lookup table having (2t+1) elements, and
the second polynomial is a polynomial for performing a manipulation of obtaining a ciphertext corresponding to a value obtained by looking up a plaintext of the second ciphertext in a lookup table having (2t+1) elements.

4. The encryption processing apparatus according to claim 3, wherein
the first polynomial is a polynomial satisfying either one of and,
the second polynomial is a polynomial satisfying.

5. The encryption processing apparatus according to claim 1, wherein the operation result of the predetermined operation is a result of an operation of a desired univariate function for the first ciphertext.

6. The encryption processing apparatus according to claim 1, wherein the operation result of the predetermined operation is a result of an operation of an even function for the first ciphertext.

7. The encryption processing apparatus according to claim 1, wherein the operation result of the predetermined operation is a result of an operation of an odd function for the first ciphertext.

8. The encryption processing apparatus according to claim 1, wherein the operation result of the predetermined operation is a value of a function of a polynomial that is an object of the operation.

9. The encryption processing apparatus according to claim 8, wherein the processor
divides the polynomial that is the object of the operation into an even function and an odd function, and
operates a value of the polynomial that is the object of the operation based on an operation result of the odd function for the first ciphertext and an operation result of the even function for the first ciphertext as the operation result of the predetermined operation.

10. The encryption processing apparatus according to claim 1, wherein the processor calculates a desired function of a finite field as the operation result by setting a dividing number of the range in the first ciphertext to a prime number.

11. The encryption processing apparatus according to claim 1, wherein the processor
reduces the number of coefficients in a ciphertext as an input, and
obtains a new ciphertext by applying a predetermined polynomial to the ciphertext with a reduced number of coefficients.

12. The encryption processing apparatus according to claim 1, wherein a process related to fuzzy authentication or fuzzy search which uses the ciphertext that is input is performed by performing the predetermined operation.

13. The encryption processing apparatus according to claim 1, wherein a query for an encryption database based on the ciphertext that is input is processed by performing the predetermined operation.

14. An encryption processing method of processing a ciphertext executed by a processor, the ciphertext being a fully homomorphic ciphertext that has a value with an error as a plaintext associated with an integer and that enables an operation between integers without decryption, the error having a predetermined variance in a divided region obtained by dividing a range into a predetermined number of regions, the method comprising:
applying a first polynomial to a first ciphertext to obtain a second ciphertext, the first polynomial being configured to be able to select an operation result in units smaller than the divided region used as one plaintext symbol corresponding to the first ciphertext in the range; and
converting two or more of plaintext symbols corresponding to the second ciphertext to the same one plaintext symbol by applying a second polynomial to the second ciphertext, to obtain a third ciphertext corresponding to an operation result of a predetermined operation.

15. A non-transitory computer-readable recording medium storing therein an encryption processing program for causing a processor to execute an encryption process of processing a ciphertext, the ciphertext being a fully homomorphic ciphertext that has a value with an error as a plaintext associated with an integer and that enables an operation between integers without decryption, the error having a predetermined variance in a divided region obtained by dividing a range into a predetermined number of regions, the encryption process including:
applying a first polynomial to a first ciphertext to obtain a second ciphertext, the first polynomial being configured to be able to select an operation result in units smaller than the divided region used as one plaintext symbol corresponding to the first ciphertext in the range; and
converting two or more of plaintext symbols corresponding to the second ciphertext to the same one plaintext symbol by applying a second polynomial to the second ciphertext, to obtain a third ciphertext corresponding to an operation result of a predetermined operation.
